(19) United States
(12) Patent Application Publication
(10) Pub. No.: US 2021/0350471 A1
(43) Pub. Date: Nov. 11, 2021

(54) SYSTEMS AND METHODS FOR UTILIZING DATA FROM ELECTRICITY MONITORING DEVICES FOR ANALYTICS MODELING

(71) Applicant: STATE FARM MUTUAL AUTOMOBILE INSURANCE COMPANY, Bloomington, IL (US)

(72) Inventors: Daryoush Hakimi-Boushehri, Bloomington, IL (US); Erin Ann Olander, Bloomington, IL (US); Christopher N. Kawakita, Normal, IL (US)

(21) Appl. No.: 16/419,819

(22) Filed: May 22, 2019

Related U.S. Application Data
(60) Provisional application No. 62/675,856, filed on May 24, 2018.

(51) Int. Cl. G06Q 40/08; G01D 4/00; G06Q 50/06

(52) U.S. Cl. CPC G06Q 40/08; G06Q 50/06; G01D 4/004

(57) ABSTRACT

Methods and apparatus for evaluating usage of individual electric or electronic devices, such as appliances, powered via an electrical system of a home, is provided. The methods and apparatus correlate the usage of electric or electronic devices about a structure, such as a home, business, or office building to claim risk profiles to identify ways to lower risk corresponding to the usage of such electric or electronic devices. The methods and apparatus identify ways to lower risk by updating one or more terms of a user policy, such as a dynamic homeowners usage-based insurance (UBI) policy, providing a recommendation for upgrading or replacing individual electric or electronic devices, and/or adjusting the electricity consumption for the individual electric or electronic devices.

### CROSS REFERENCE TO RELATED APPLICATIONS

This application claims priority to and the benefit of the filing date of provisional U.S. Application Ser. No. 62/675,856, filed May 24, 2018 and entitled “Systems and Methods for Utilizing Data from Electricity Monitoring Devices for Analytics Modeling,” the disclosure of which is hereby incorporated herein by reference in its entirety.

### FIELD OF THE DISCLOSURE

The present disclosure relates to systems, methods, apparatus, and non-transitory computer readable media to evaluate usage of electric or electronic devices, such as appliances, powered via an electrical system of a structure, such as a home, business, or office building, and/or providing usage-based insurance (UBI).

### BACKGROUND

Several types of organizations, such as insurance companies, collect data from customers to determine an insurance quote or coverage. For example, for homeowners insurance coverage, such organizations collect the customer's address, and from the address, may determine if the home is in an area prone to these natural disasters. After determining a risk based upon such information and other factors, insurance companies may set insurance premiums and other terms in the insurance coverage. However, conventional methods of determining risk do not account for tracked energy usage within the home. Conventional techniques may have other drawbacks as well.

### BRIEF SUMMARY

Method, apparatus, systems, and non-transitory media are described that may, inter alia, evaluate usage of electric or electronic devices, such as electrical appliances and even vehicles (e.g., electric car) powered via an electrical system of a structure (e.g., a home), on an individual device basis. An Electricity Monitoring (EM) device may be within the home or proximal to the home, such as in the vicinity of the home's electrical system (e.g., main electrical distribution board, or “breaker box”). The EM device may wirelessly sense, detect, monitor, and/or generate Electricity Flow (EF) datasets indicative of the electricity flowing to each and every electric or electronic device within a home (such as every device connected to the home's electrical system and drawing power therefrom). The EM device may wirelessly identify the electricity flow to and from each electric or electronic device based upon each device's unique electronic signature (or “fingerprint”). One or more computing devices (e.g., a server) may be configured with a correlation rule specifying one or more parameters that indicate whether EF datasets of each electric or electronic device as measured by the EM device, when compared to claim risk profiles, exceed a minimum level of the risk defined in the claim risk profile, and if so, identify ways to lower the risk corresponding to the electricity usage of such electric or electronic devices.

To do so, some embodiments include the computing device storing or accessing a database of various claim risk profiles, which may be generated by the computing device by correlating historical electrical usage, flow, and/or consumption of known electric or electronic devices to risk defined by the computing device. Further, the computing device may be configured with a correlation rule specifying one or more parameters that indicate which portion of the EF datasets, when compared to the one or more of the claim risk profiles, exceed a minimum level of the defined risk. In the event that one or more comparisons result in the EF dataset exceeding the minimum level of the defined risk, the computing device may identify ways to lower risk corresponding to the electricity usage of the electric or electronic device identified in the EF dataset.

In addition, embodiments include the comparison process providing more accurate results over time, as the pool of known claim risk profiles and/or known correlation rules may be increased or developed as new claim risk profiles and correlation rules are identified and added. Thus, the performance and capabilities of the method, apparatus, system, or non-transitory media is thereby improved over time.

The EF datasets, claim risk profiles, and/or known correlation rules may be used to offer various types of usage-based insurance (UBI) products. UBI products may provide usage-based homeowners, auto, or personal articles insurance. For instance, homeowners UBI may cover a home in which the EM device resides, the personal articles UBI may cover one or more appliances, electronics, or other devices within the home that use electricity, and the auto UBI may cover one or more vehicles, such as electric or hybrid vehicles, that consume electricity from the home to recharge vehicle batteries. The UBI products may generated and offered in near-real time to consumers, such as by pushing UBI quotes to mobile devices or the like. The UBI products may be dynamic or static, and may be for variable or set periods of time, such for a week, month, or six-month period.

In one aspect, a computer-implemented method of evaluating usage of one or more individual electric or electronic devices powered via an electrical system of a home may be provided. The method may include (1) receiving, by one or more processors, EF datasets indicative of the one or more individual electric or electronic devices' electricity consumption from a Electricity Monitoring (EM) device configured to wirelessly detect unique electric signatures of the one or more individual electric or electronic devices via wireless communication or data transmission over one or more radio links or communication channels; (2) generating, by the one or more processors, one or more claim risk profiles, each including a risk defined by a computing device independent of the EM device, wherein the risk corresponds to historical electricity consumption information; (3) generating, by the one or more processors, a correlation rule specifying one or more parameters that indicate which portion of the EF datasets when compared to the one or more of the claim risk profiles exceed a minimum level of the risk; (4) detecting, by the one or more processors, whether the EF dataset contains risk that meets or exceeds the minimum level of the risk in accordance with the one or more parameters specified by the correlation rule; and (5) when the EF dataset contains risk that meets or exceeds the minimum level of the risk, dynamically updating, by the one or more processors, at least one of: a usage-based insurance (UBI) product or UBI rate associated with a specific home, or device or vehicle that consumes electricity within the home and that is monitored by the EM device, one or more terms of a user policy (such as a UBI or other insurance policy), or a usage behavior profile with a recommendation for upgrading or replacing the one or more individual electric or electronic devices, or a service recommendation for adjusting the one or more individual electric or electronic devices' electricity consumption. The method may include additional, less, or alternate actions, including those discussed elsewhere herein.

In another aspect, a non-transitory computer readable media may be described having instructions stored thereon in a computing device to evaluate usage of one or more individual electric or electronic devices powered via an electrical system of a home that, when executed by a processor, cause the processor to: (1) receive EF datasets indicative of the one or more individual electric or electronic devices' electricity consumption from a Electricity Monitoring (EM) device configured to wirelessly detect unique electric signatures of the one or more individual electric or electronic devices via wireless communication or data transmission over one or more radio links or communication channels; (2) generate one or more claim risk profiles each corresponding to a risk defined by a computing device independent of the EM device, wherein the risk corresponds to historical electricity consumption information; (3) generate a correlation rule specifying one or more parameters that indicate which portion of the EF datasets when compared to the one or more of the claim risk profiles exceed a minimum level of the risk; (4) detect whether the EF dataset contains risk that meets or exceeds the minimum level of the risk in accordance with the one or more parameters specified by the correlation rule; and (5) when the EF dataset contains risk that meets or exceeds the minimum level of the risk, dynamically update at least one of: a usage-based insurance (UBI) product or UBI rate associated with a specific home, or device or vehicle that consumes electricity within the home and that is monitored by the EM device, one or more terms of a user policy (such as a UBI or other insurance policy), or a usage behavior profile with a recommendation for upgrading or replacing the one or more individual electric or electronic devices, or a service recommendation for adjusting the one or more individual electric or electronic devices' electricity consumption. The non-transitory computer readable media may include instructions with additional, less, or alternate functionality, including that discussed elsewhere herein.

In yet another aspect, a risk correlation (RC) engine may be described including (1) a memory unit configured to store instructions for evaluating usage of one or more individual electric or electronic devices powered via an electrical system of a home, and (2) a processor configured to: (i) receive EF datasets indicative of the one or more individual electric or electronic devices' electricity consumption from a Electricity Monitoring (EM) device configured to wirelessly detect unique electric signatures of the one or more individual electric or electronic devices via wireless communication or data transmission over one or more radio links or communication channels; (ii) generate the one or more claim risk profiles, each corresponding to a risk defined by a computing device independent of the EM device, wherein the risk corresponds to historical electricity consumption information; (iii) generate a correlation rule specifying one or more parameters that indicate which portion of the EF datasets when compared to the one or more of the claim risk profiles exceed a minimum level of the risk; (iv) detect whether the EF dataset contains risk that meets or exceeds the minimum level of the risk in accordance with the one or more parameters specified by the correlation rule; and (v) when the EF dataset contains risk that meets or exceeds the minimum level of the risk, dynamically update, by the one or more processors, at least one of: a usage-based insurance (UBI) product or UBI rate associated with a specific home, or device or vehicle that consumes electricity within the home and that is monitored by the EM device, one or more terms of a user policy (such as a UBI or other insurance policy), or a usage behavior profile with a recommendation for upgrading or replacing the one or more individual electric or electronic devices, or a service recommendation for adjusting the one or more individual electric or electronic devices' electricity consumption. The RC engine may include additional, fewer, or alternate components, including those discussed elsewhere herein.

Another aspect may be directed to providing a recommendation for upgrading and/or replacing an individual electric or electronic device. For instance, a computer-implemented method of evaluating usage of one or more individual electric or electronic devices powered via an electrical system of a home may be provided. The method may include: (1) receiving, by one or more processors, a dataset indicative of the one or more individual electric or electronic devices' electricity consumption from a Electricity Monitoring (EM) device configured to wirelessly detect unique electric signatures of the one or more individual electric or electronic devices via wireless communication or data transmission over one or more radio links or communication channels; (2) generating, by the one or more processors, one or more claim risk profiles, each including a risk defined by a computing device independent of the EM device, wherein the risk corresponds to historical electricity consumption information; (3) generating, by the one or more processors, a correlation rule specifying one or more parameters that indicate which portion of the dataset when compared to the one or more of the claim risk profiles exceed a minimum level of the risk; (4) detecting, by the one or more processors, whether the dataset contains risk that meets or exceeds the minimum level of the risk in accordance with the one or more parameters specified by the correlation rule; and/or (5) when the dataset contains risk that meets or exceeds the minimum level of the risk, dynamically updating, by the one or more processors, a user profile with a recommendation for upgrading or replacing the one or more individual electric or electronic devices. The method may include additional, less, or alternate actions, including those discussed elsewhere herein.

Another aspect may be directed to providing a recommendation for adjusting usage of an individual electric or electronic device. For instance, a computer-implemented method of evaluating usage of one or more individual electric or electronic devices powered via an electrical system of a home may be provided. The method may include (1) receiving, by one or more processors, a dataset indicative of the one or more individual electric or electronic devices' electricity consumption from a Electricity Monitoring (EM) device configured to wirelessly detect unique electric signatures of the one or more individual electric or electronic devices via wireless communication or data transmission over one or more radio links or communication channels; (2) generating, by the one or more processors, one or more claim risk profiles, each including a risk defined by a computing device independent of the EM device, wherein the risk corresponds to historical electricity consumption information; (3) generating, by the one or more processors, a correlation rule specifying one or more parameters that indicate which portion of the dataset when compared to the one or more of the claim risk profiles exceed a minimum level of the risk; (4) detecting, by the one or more processors, whether the dataset contains risk that meets or exceeds the minimum level of the risk in accordance with the one or more parameters specified by the correlation rule; and/or (5) when the dataset contains risk that meets or exceeds the minimum level of the risk, dynamically updating, by the one or more processors, a user profile with a service recommendation for adjusting the electricity consumption for the one or more individual electric or electronic devices. The method may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems, methods, apparatus, and non-transitory computer readable media disclosed herein. It should be understood that each Figure depicts a particular aspect of the disclosed systems, methods, apparatus, and non-transitory computer readable media, and that each of the Figures is intended to accord with a possible aspect thereof. Further, wherever possible, the following description refers to the reference numerals included in the following Figures, in which features depicted in multiple Figures are designated with consistent reference numerals.

There are shown in the Figures arrangements which are presently discussed, it being understood, however, that the present embodiments are not limited to the precise arrangements and instrumentalities shown, wherein:

FIG. 1 illustrates a block diagram of an exemplary system including an electricity monitoring (EM) device configured to wirelessly sense, retrieve, collect, generate, and/or compile device-specific EF datasets, and components configured to evaluate usage of one or more individual electric or electronic devices powered via an electrical system of a home in accordance with one aspect of the present disclosure;

FIG. 2 illustrates an exemplary system configured to monitor electrical activity including electricity usage about a home;

FIG. 3 illustrates a block diagram of an exemplary EF dataset indicative of the electricity consumption from one or more individual electric or electronic devices detected by a Electricity Monitoring (EM) device in accordance with one aspect of the present disclosure;

FIG. 4 illustrates a block diagram of an exemplary risk correlation (RC) engine in accordance with one aspect of the present disclosure;

FIG. 5 illustrates exemplary historical claims data and a risk profile based upon the exemplary historical claims data in accordance with one aspect of the present disclosure;

FIG. 6 illustrates an exemplary screenshot of a graphical interface to facilitate user specification of correlation rule parameters in accordance with one aspect of the present disclosure;

FIG. 7 illustrates exemplary historical claims data and a risk profile based upon the exemplary historical claims data in accordance with one aspect of the present disclosure;

FIG. 8 illustrates an exemplary method for evaluating usage of one or more individual electric or electronic devices powered via an electrical system of a home in accordance with one aspect of the present disclosure;

FIG. 9A illustrates an exemplary method for generating a claim risk profile in accordance with one aspect of the present disclosure;

FIG. 9B illustrates an exemplary method for generating a correlation rule in accordance with one aspect of the present disclosure;

FIG. 10 illustrates an exemplary method for dynamically updating one or more terms of a user policy (such as a UBI policy) contained in a user profile in accordance with one aspect of the present disclosure;

FIG. 11 illustrates an exemplary method for providing a recommendation for upgrading or replacing an electric device in accordance with one aspect of the present disclosure;

FIG. 12 illustrates an exemplary method for providing a service recommendation for adjusting the electricity usage for an electric or electronic device in accordance with one aspect of the present disclosure; and

FIG. 13 illustrates exemplary historical claims data in accordance with one aspect of the present disclosure.

The Figures depict preferred embodiments for purposes of illustration only. Alternative embodiments of the systems, methods, apparatus, and non-transitory computer readable media illustrated herein may be employed without departing from the principles of the invention described herein.

### DETAILED DESCRIPTION

Various embodiments are described herein related to evaluating usage of individual electric or electronic devices. As further explained below, businesses or entities may provide value to their customers upon evaluation of such electric or electronic devices individually.

The present embodiments may relate to, inter alia, monitoring electricity flow to, and within, a home or other type of property. Electricity flowing to individual electric devices, such as smart appliances or other appliances, electronics, vehicles (e.g., cars, boats, motorcycles), and/or mobile devices may be detected and monitored for usage trends. For example, abnormal electric flow to various devices may be indicate that failure is imminent, maintenance is required, device replacement is required or recommended, de-energization is recommended, or other corrective action is prudent.

In one aspect, a home may have a “smart” central controller that may be wirelessly connected, or connected via hard-wire, with various household related items, devices, and/or sensors. The central controller may be associated with any type of property, such as homes, office buildings, restaurants, farms, and/or other types of properties. The central controller may be in wireless or wired communication with various “smart” items or devices, such as smart appliances (e.g., clothes washer, dryer, dish washer, refrigerator, etc.); smart heating devices (e.g., furnace, space heater, etc.); smart cooling devices (e.g., air conditioning units, fans, ceiling fans, etc.); smart plumbing fixtures (e.g., toilets, showers, water heaters, sump pumps, piping, interior and yard sprinklers, etc.); smart cooking devices (e.g., stoves, ovens, grills, microwaves, etc.); smart wiring, lighting, and lamps; smart personal vehicles; smart thermostats; smart windows, doors, or garage doors; smart window blinds or shutters; electric or hybrid vehicles; and/or other smart devices and/or sensors capable of wireless or wired communication. Each smart device (or sensor associated therewith), as well as the central controller, may be equipped with a processor, memory unit, software applications, wireless transceivers, local power supply, various types of sensors, and/or other components.

The central controller may also be in wired or wireless communication with an Electricity Monitoring (EM) device. The EM device may wirelessly detect and monitor the electricity flow to, or usage or consumption by, each electronic or electric device, or in proximity to, the home. The central controller may also combine the Electricity Flow (EF) data generated by the EM device with other types or sources of data, such as interconnected home telematics data, autonomous or smart vehicle telematics data, home or vehicle telematics data gathered by a mobile device (e.g., smart phone, smart glasses, smart watch, etc.), wearable electronic data, mobile device data, etc. In addition to gathering data generated by the EM device associated with electricity usage/flow/consumption, the central controller may also remotely gather data from the electronic or electric devices (or sensors associated therewith) dispersed around or otherwise interconnected within the property. The EF dataset described herein may be the EF data or combination of EF data and other data.

In some embodiments, each of the electronic or electric devices may be included on an electronic or other inventory list associated with the property. Further, the inventory list may include a monetary value associated with each of the electronic or electric devices. In some embodiments, the monetary value may correspond to the replacement value, the MSRP, or other metric associated with the corresponding electronic or electric device. The monetary value may be manually entered by a user or automatically determined based upon various factors. The electronic or electric devices themselves may store the monetary value, such as in a data tag or other type of storage or memory unit. The inventory list may further detail a location (e.g., GPS coordinates, a room of the property, an area or section of the property, or other location indication) of each of the electronic or electric devices. In this regard, multiple electronic or electric devices may be associated with a single area or location of the property (e.g., a basement, a bathroom, a kitchen, a first floor, etc.).

A customer (who may be referred to interchangeably herein as an “insured,” “insured party,” “owner,” “homeowner,” “policyholder,” “insurance customer,” “claimant,” and/or “potential claimant”) may opt-in to an insurance rewards, discount program, financial planning, or service alert (e.g., alert for tips or suggestions for energy savings). The customer may send datasets associated with their home that was or is generated by the EM device, along with various types of telematics data (home, auto, mobile device, etc.), to a remote server or provider via wireless communication or data transmission over one or more radio links or communication channels. In return, risk averse customers may be provided with certain benefits or information after the datasets is analyzed by the remote server or provider. In some embodiments, the central controller may be an electronic device, such as a laptop, desktop computer, a mobile phone, etc., that may receive information from the insurance provider or other provider to provide the customer with such information or benefits.

Generally, the datasets gathered by the provider may be utilized for insurance, financial, or servicing purposes. The information may be used to process or manage insurance covering the home, residence or apartment, personal belongings, vehicles, etc. For instance, UBI products covering a home, apartment, condo, vehicle, or personal articles may be dynamically updated and/or updated periodically (weekly, monthly, etc.) using the EM device data to continuous update the UBI insurance rate to more accurately match price to actual risk.

The systems and methods therefore offer a benefit to customers by automatically adjusting insurance policies based upon an accurate assessment of personal property value, and current risk. Further, the systems and methods may be configured to automatically populate proposed insurance claims resulting from property damage via data gathered from smart devices. These features reduce the need for customers to manually assess property value and/or manually initiate insurance claim filing procedures. Further, as a result of the automatic claim generation, insurance providers may experience a reduction in the amount of processing and modifications necessary to process the claims. Moreover, by implementing the systems and methods, insurance providers may stand out as a cost-effective insurance provider, thereby retaining existing customers and attracting new customers.

As another example, the datasets gathered by a financial provider (e.g., lender) may be used to provide a recommendation in the form of a loan, a line of equity, a line of credit, a discount, or an incentive to purchase a replacement appliance to replace or assist an existing appliance. As another example, the datasets gathered by a service provider (e.g., a utilities company) may be used to provide an energy consumption evaluation service to help the customer save money or utilize appliances more efficiently with smarter resource management.

### Exemplary Electricity Flow (EF) Dataset Evaluation System

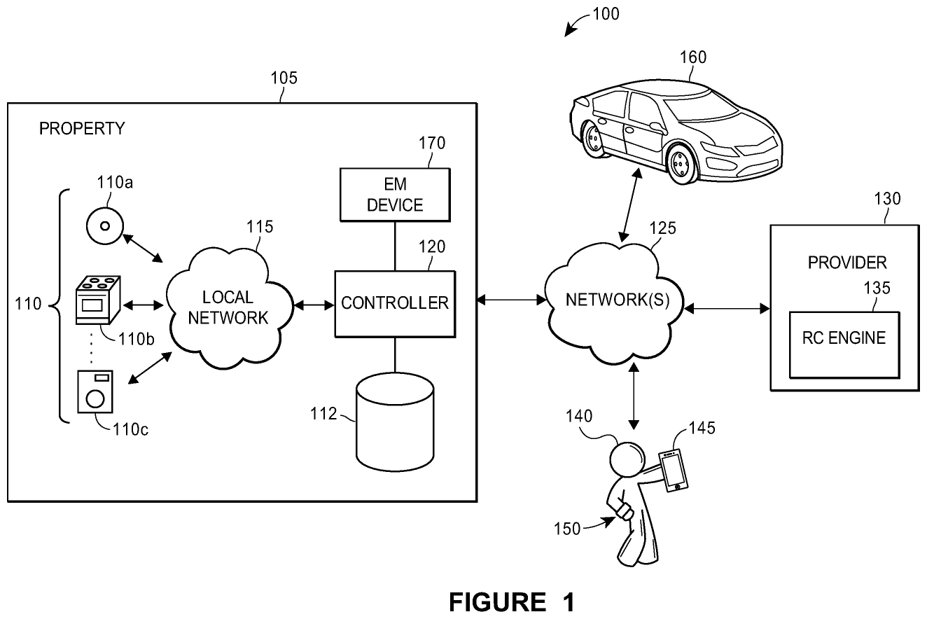

FIG. 1 illustrates a block diagram of an exemplary EF dataset evaluation system 100 in accordance with one aspect of the present disclosure. EF dataset evaluation system 100 may facilitate the evaluation of usage of one or more individual electric or electronic devices powered via an electrical system of a home.

As illustrated in FIG. 1, the system 100 may include a property 105 that contains a controller 120, a plurality of devices 110 (e.g., appliances), and an Electricity Monitoring (EM) device 170 that may be each connected to a local communication network 115 (or to the controller 120 directly or indirectly). Each of the plurality of devices 110 and/or the EM device 170 may be a “smart” device that may be configured with one or more sensors capable of sensing and communicating operating data associated with the corresponding device 110. The EM device 170 may be configured to wirelessly sense, retrieve, collect, generate, and/or compile device-specific EF datasets based upon electrical activity detected from the plurality of devices 110. As used herein, “EF dataset” and/or “EF dataset” may be used interchangeably with “dataset” and/or “datasets.”

As shown in FIG. 1, the plurality of devices 110 may include, as just a few examples, a smart alarm system 110a, a smart stove 110b, and a smart washing machine 110c. Each of the plurality of devices 110, as well as the EM device 170, may be located within or proximate to the property 105 (generally, “on premises” or “about the property 105”). Although FIG. 1 depicts only one property 105, it should be appreciated that multiple properties may be envisioned, each with its own controller and devices.

Further, it should be appreciated that additional or fewer devices may be present about the property 105. For example, devices present in the property 105 may include a refrigerator, a microwave, a toaster, a television, a computer, telephone, a sound system, a light bulb or another lighting fixture, a washer, a dryer, an electrically-powered heating system, air conditioning system, water heater, and/or other suitable devices. Finally, it should be understood that, while a home is generally described herein, the property 105 may be an office building or another suitable property or structure.

In some cases, the plurality of devices 110 may be purchased from a manufacturer with the “smart” functionally incorporated therein. In other cases, the plurality of devices 110 may have been purchased as “dumb” devices and subsequently modified to add the “smart” functionality to the device. For example, a homeowner may purchase an alarm system and then install sensors on or near a door to detect when a door has been opened and/or unlocked.

Additionally, the plurality of devices 110, and/or the EM device 170, may be configured to communicate either directly or indirectly with controller 120, such as via the local communication network 115. The local communication network 115 may facilitate any type of data communication between devices and controllers located on or proximate to the property 105 via any standard or technology (e.g., LAN, WLAN, any IEEE 602 standard including Ethernet, and/or others). The local communication network 115 may further support various short-range communication protocols such as Bluetooth®, Bluetooth® Low Energy, near field communication (NFC), radio-frequency identification (RFID), and/or other types of short-range protocols.

According to certain aspects, the plurality of devices 110, as well as the EM device 170, may transmit, to the controller 120 via the local communication network 115, datasets indicative of operational data gathered from sensors associated with the plurality of devices 110, such as via wired or wireless communication or data transmission over one or more radio links or communication channels. In other embodiments, the EM device 170 may transmit the datasets directly to the provider 130.

For the EM device 170, the datasets may include data indicative of electricity flow to and/or from various smart or other electronic devices, including the plurality of devices 110. The datasets may also include electricity or energy usage for each electronic component, device, outlet, etc. within a home—such as data indicating the electricity each device or room is using. For instance, energy usage of air conditioners, washers, dryers, dish washers, refrigerators, stoves, stoves, microwave stoves, televisions, lamps, outlets, computers, laptops, mobile devices, other electronic devices, etc. may all be determined by the EM device 170. The EM device 170 may wirelessly detect each flow of electricity to and/or from each different electronic device by identifying each electronic device by its unique electronic or electrical signature (or “fingerprint”). The EM device 170 may then generate electricity usage or flow data for each electronic device within the home, or connected to the home's electrical system (such as a hybrid or fully electric vehicle 160 having its battery wiredly or wirelessly charged by the home's electrical system).

In some embodiments, the datasets may indicate that a window has been shattered; the presence of a person, fire, or water in a room; the sound made near a smart device; and/or other information pertinent to an operation state or status of the plurality of devices 110. In some embodiments, the datasets may include a timestamp representing the time that the datasets was recorded. In some cases, the plurality of devices 110, as well as the EM device 170, may transmit, to the controller 120 and/or provider 130, various data and information associated with the plurality of devices 110.

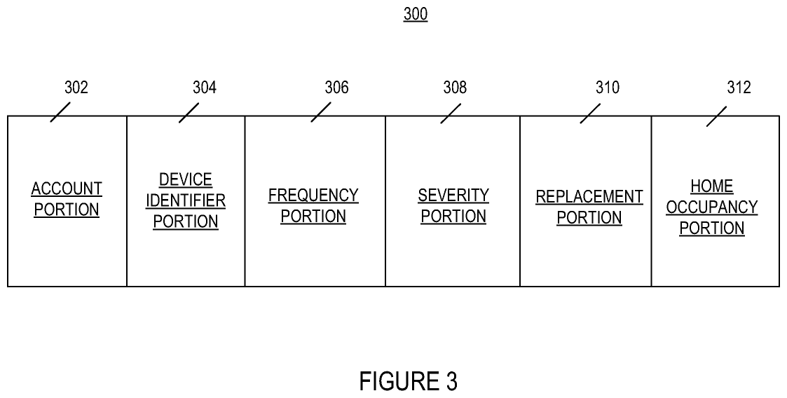

In particular, the data and information may include location data within the property, as well as various costs and prices for replacement devices similar to the plurality of devices 110, which may be included in replacement portion 310 of dataset 300 as will be described further with respect to FIG. 3 below. For example, a washing machine may include a component such as a data tag that stores a location of the washing machine within the property 105, a retail price of the washing machine, and replacement costs of various parts of (or the entirety of) the washing machine.

The various data and information may be programmable and updatable by an individual or automatically by the controller 120, in some cases. For example, the data tag may be programmable and configured to transmit, via the local communication network 115 and/or one or more other networks 125, upgrade data and information pertaining to upgrading the plurality of devices 110, such as a retail price of an upgraded model within the same brand of the washing machine, a retail price of an upgraded model of a different brand than the washing machine, performance characteristics of an upgraded model within the same brand of the washing machine, performance characteristics of an upgraded model of a different brand than the washing machine, and/or replacement costs of various upgradable parts compatible with the same washing machine, to the provider 130. Therefore, the controller 120 may be configured to communicate with provider 130 via the local communication network 115 and/or one or more other networks 125.

The controller 120 may be coupled to a database 112 that stores various datasets and information associated with the plurality of devices 110. In some embodiments, the database 112 may also store upgrade data and information pertaining to upgrading the plurality of devices 110. Although FIG. 1 depicts the database 112 as coupled to the controller 120, it is envisioned that the database 112 may be maintained in the “cloud” such that any element of the system 100 capable of communicating over either the local network 115 or one or more other networks 125, such as provider 130, may directly interact with the database 112. In some embodiments, the database 112 organizes the datasets and/or upgrade data and information according to individual device 110 the dataset may be associated with and/or the room or subsection of the property in which the dataset was recorded. Further, the database 112 may maintain an inventory list that may include the plurality of devices 110 as well as various data and information associated with the plurality of devices 110 (e.g., locations, replacement costs, etc.).

According to some embodiments, the network(s) 125 may facilitate any data communication between the controller 120 located on the property 105 and entities or individuals remote to the property 105 via any standard or technology (e.g., GSM, CDMA, TDMA, WCDMA, LTE, EDGE, OFDM, GPRS, EV-DO, UWB, IEEE 602 including Ethernet, WiMAX, and/or others). In some cases, both the local network 115 and the network 125(s) may utilize the same technology.

In some embodiments, provider 130 may be associated with a plurality of servers, each server associated with a manufacturer of the plurality of devices 110, a retailer selling the plurality of devices 110, and/or an independent third-party provider, that collects information concerning the plurality of devices 110. Generally, the independent third-party provider may be any individual, group of individuals, company, corporation, or other type of entity that may issue insurance policies, provide financial assistance, and/or offer various energy-savings strategies for customers, such as a homeowners or renters associated with the property 105 or an insured.

For example, the provider 130 may perform insurance underwriting and set premiums, offer a recommendation in the form of a loan, a line of equity, a line of credit, a discount, or an incentive to purchase a replacement device 110 to replace or assist an existing one or more of the plurality of devices 110, and/or offer an energy consumption evaluation service to help the customer save money or utilize one or more of the devices 110 more efficiently with smarter resource management of one or more of the plurality of devices 110. A replacement device 110 may be determined based upon, for example, product ratings, user ratings, and/or similarity of the replacement device to the existing electric device (e.g., the make and model of the existing electric or electronic device or appliance based upon the electricity consumption data generated or collected by the wireless EM device).

According to the present embodiments, the provider 130 may include a risk correlation (RC) engine 135 configured to evaluate usage of the devices 110 and correlate the usage of the devices 110 to claim risk profiles to identify risks corresponding to certain ways of using devices 110, and if possible, to further identify ways of lowering the risk as discussed herein. Although FIG. 1 depicts the RC engine 135 as a part of the provider 130, it should be appreciated that the RC engine 135 may be separate from (and connected to or accessible by) the provider 130.

Further, although the present disclosure describes the systems and methods as being facilitated in part by the provider 130 capable of issuing insurance policies to customers, it should be appreciated that other non-insurance related entities may implement the systems and methods. For example, a general contractor may aggregate the insurance-risk data across many properties to determine which devices (e.g., appliances or products) provide the best protection against specific causes of loss, and/or deploy the appliances or products based upon where causes of loss are most likely to occur. Accordingly, it may not be necessary for the property 105 to have an associated insurance policy for the property owners to enjoy the benefits of the systems and methods.

Generally, in some embodiments, the RC engine 135 may be configured to facilitate various insurance-related processing associated with insurance policies for the property 105. In one aspect, the RC engine 135 may receive a dataset indicative of electricity consumption of one or more of the devices 110 and determine any corresponding adjustments to a policy (e.g., insurance policy, homeowner insurance policy, or UBI policy) for a customer or homeowner of the property 105. To make the determination of whether to make adjustments to a policy, the RC engine 135 may (1) generate a claim risk profile having a risk defined by the RC engine 135, (2) generate a correlation rule specifying one or more parameters that indicate which portion of the datasets of one or more of the devices 110, when compared to the one or more of the claim risk profiles, exceed a minimum level of the risk, and/or (3) detect whether the dataset contains risk that meets or exceeds the minimum level of the risk in accordance with the one or more parameters specified by the correlation rule. The risk defined by the RC engine 135 may correspond to historical electricity consumption information collected from known electric or electronic devices similar to the devices 110.

For example, the RC engine 135 may generate a fire risk profile having a defined “fire risk” that corresponds to usage conditions (e.g., frequency of use, severity of use) of known electric stoves. The fire risk profile may indicate that the more frequently or severely a stove is used (which may correlate to excessive electricity consumption), the more likely it is that a fire may start in the home as a result of the frequent or severe usage of the stove. The RC engine 135 may be configured to execute one or more software applications that may generate a correlation rule specifying one or more parameters that indicate which portion (e.g., frequency portion, severity portion) of the datasets of a stove 110, when compared to the fire risk profile (e.g., usage conditions of the claim risk profile), exceed a minimum level of the risk.

Accordingly, subsequent to mapping the frequency portion and/or severity portion of the datasets of the stove 110 onto the frequency of use and/or severity of use of known electric stoves accounted for in the fire risk profile, respectively, as indicated by the correlation rule, the RC engine 135 may identify the risk corresponding to the datasets of the stove 110 in accordance with the fire risk profile. Should the risk exceed a minimum level of the risk defined by the correlation rule, the RC engine 135 may dynamically update one or more terms of a user policy of the customer or homeowner of the property 105, in response to risky stove usage—such as dynamically update the current or future UBI rate or premium for a homeowners UBI product. The RC engine 135 may communicate any generated or determined information to the controller 120 (and vice-versa) via the network(s) 125 to inform the customer or homeowner of the property 105 of the update term(s) of the user policy (such as the homeowners UBI product).

Similarly, in some embodiments, the RC engine 135 may be configured to facilitate various finance-related processing associated with acquiring replacement devices 110 or parts thereof for the property 105. In one aspect, the RC engine 135 may receive a dataset indicative of electricity consumption of one or more of the devices 110 and determine any corresponding adjustments to a financial recommendation, such as terms of a loan (e.g., length of the loan, an interest rate, and/or monthly payment), a line of equity, a line of credit, a discount, or an incentive, for purchasing a replacement device 110 to replace or assist an existing one or more of the plurality of devices 110.

To make the determination of whether to make adjustments to a financial recommendation, the RC engine 135 may (1) generate a claim risk profile having a risk defined by the RC engine 135, (2) generate a correlation rule specifying one or more parameters that indicate which portion of the datasets of one or more of the devices 110, when compared to the one or more of the claim risk profiles, exceed a minimum level of the risk, and (3) detect whether the dataset contains risk that meets or exceeds the minimum level of the risk in accordance with the one or more parameters specified by the correlation rule. The risk defined by the RC engine 135 may correspond to historical electricity consumption information collected from known electric or electronic devices similar to the devices 110.

For example, the RC engine 135 may generate a fire risk profile having a defined “fire risk” that corresponds to usage conditions (e.g., frequency of use, severity of use) of known electric stoves. The fire risk profile may indicate that the more frequently or severely a stove is used (which may correlate to excessive electricity consumption), the more likely it is that a fire may start in the home as a result of the frequent or severe usage of the stove. The RC engine 135 may be configured to execute one or more software applications that may generate a correlation rule specifying one or more parameters that indicate which portion (e.g., frequency portion, severity portion) of the datasets of a stove 110, when compared to the fire risk profile (e.g., usage conditions of the claim risk profile), exceed a minimum level of the risk.

Accordingly, subsequent to mapping the frequency portion and/or severity portion of the datasets of the stove 110 onto the frequency of use and/or severity of use of known electric stoves accounted for in the fire risk profile, respectively, as indicated by the correlation rule, the RC engine 135 may identify the risk corresponding to the datasets of the stove 110 in accordance with the fire risk profile. Should the risk exceed a minimum level of the risk defined by the correlation rule, the RC engine 135 may dynamically update one or more terms of a financial recommendation for acquiring replacement devices 110 or parts thereof for the property 105, in response to risky stove usage. The RC engine 135 may communicate any generated or determined information to the controller 120 (and vice-versa) via the network(s) 125 to inform the customer or homeowner of the property 105 of the update term(s) of the financial recommendation.

Similarly, in some embodiments, the RC engine 135 may be configured to facilitate various service-related processing associated with offering an energy consumption evaluation service for the property 105 to help the customer or homeowner of the property 105 save money or utilize one or more of the devices 110 more efficiently with smarter resource management 110. In one aspect, the RC engine 135 may receive a dataset indicative of electricity consumption of one or more of the devices 110 and determine any corresponding adjustments to a home health report for the devices 110. To make the determination of whether to make adjustments to a home health report, the RC engine 135 may (1) generate a claim risk profile having a risk defined by the RC engine 135, (2) generate a correlation rule specifying one or more parameters that indicate which portion of the datasets of one or more of the devices 110, when compared to the one or more of the claim risk profiles, exceed a minimum level of the risk, and (3) detect whether the dataset contains risk that meets or exceeds the minimum level of the risk in accordance with the one or more parameters specified by the correlation rule. The risk defined by the RC engine 135 may correspond to historical electricity consumption information collected from known electric or electronic devices similar to the devices 110.

For example, the RC engine 135 may generate a fire risk profile having a defined “fire risk” that corresponds to usage conditions (e.g., frequency of use, severity of use) of known electric stoves. The fire risk profile may indicate that the more frequently or severely a stove is used (which may correlate to excessive electricity consumption), the more likely it is that a fire may start in the home as a result of the frequent or severe usage of the stove. The RC engine 135 may be configured to execute one or more software applications that may generate a correlation rule specifying one or more parameters that indicate which portion (e.g., frequency portion, severity portion) of the datasets of a stove 110, when compared to the fire risk profile (e.g., usage conditions of the claim risk profile), exceed a minimum level of the risk.

Accordingly, subsequent to mapping the frequency portion and/or severity portion of the datasets of the stove 110 onto the frequency of use and/or severity of use of known electric stoves accounted for in the fire risk profile, respectively, as indicated by the correlation rule, the RC engine 135 may identify the risk corresponding to the datasets of the stove 110 in accordance with the fire risk profile. Should the risk exceed a minimum level of the risk defined by the correlation rule, the RC engine 135 may dynamically make adjustments to a home health report in response to risky stove usage, such as providing updated strategies of efficiently using the stove 110 to lower risk of a fire. The RC engine 135 may communicate any generated or determined information to the controller 120 (and vice-versa) via the network(s) 125 to inform the customer or homeowner of the property 105 of the adjustments to the home health report.

In some embodiments, the RC engine 135 may also be in communication, via the network(s) 125, with a remote electronic device 145 or remote wearable electronic device 150 associated with an individual 140 (such as via wireless communication or data transmission over one or more radio links or communication channels). The RC engine 135 may receive device positioning (e.g., GPS) data from the devices 145 and/or 150, the positioning indicating a location of the individual 140 in possession of the devices 145 and/or 150. Generally, the device positioning data may be used to determine (e.g., at the RC engine 135) a proximity of the individual 140 to the property 105. Effectively, the device positioning data may indicate that the individual was within the property 105 at a particular time in the past, or that the individual is presently within the property. Such information may be documented in the datasets, and may be used at the RC engine 135 to compare with positioning data included within historical electricity consumption information collected from known electric or electronic devices similar to the devices 110.

In some embodiments, the individual 140 may have an insurance policy (e.g., a home insurance policy or homeowners UBI policy) for the property 105 or a portion of the property 105, or may otherwise be associated with the property 105 (e.g., the individual 140 may own or live in the property 105). The electronic devices 145 and 150 may be a smartphone, a desktop computer, a laptop, a tablet, a phablet, a smart phone, a smart watch, smart glasses, smart contact lenses, wearable electronic device, or any other electronic or computing device. Of course, when the individual 140 is within the property 105, the controller 120 may be a part of a similar electronic device, such as a desktop computer, a laptop, a tablet, a phablet, a smart phone, a smart watch, smart glasses, smart contact lenses, wearable electronic device, or any other electronic or computing device. In one embodiment, the UBI insurance policy may also include or be a personal articles UBI policy covering the electronic devices monitored by the EM device and consuming electricity within the home.

The controller 120 or RC engine 135 may also be in communication, via the network(s) 125, with a vehicle 160 associated with an individual 140 or home. The vehicle 160 may be an autonomous vehicle, semi-autonomous vehicle, smart vehicle, electric or hybrid vehicle, or other vehicle configured for wireless communication and data transmission over one or more radio links or communication channels. In another embodiment, the UBI insurance policy may also include or be an auto UBI policy covering one or more vehicles monitored by the EM device and consuming electricity within the home.

Although FIG. 1 depicts certain entities, components, and devices, it should be appreciated that additional or alternate entities and components are envisioned.

### Exemplary System for Monitoring Electrical Activity

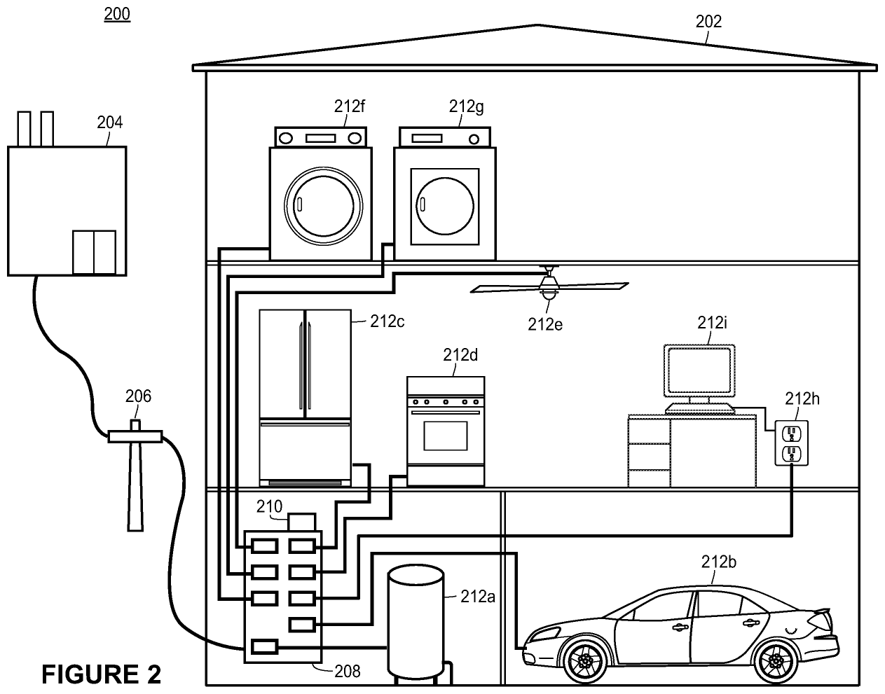

FIG. 2 illustrates an exemplary system 200 configured to monitor electrical activity including electricity usage about a home 202, which may correspond to property 105 of FIG. 1 in one embodiment. Though a home 202 is depicted, the home may instead be another type of structure (e.g., a structure housing offices and/or a business). Conventionally, the home 202 may be powered by electricity received, for example, from a power plant 204 via an electrical power grid 206. Other sources of electricity (e.g., another widespread electrical network, a local generator, a local solar panel array, etc.) are possible.

In any case, upon entering the home 202, the electricity may be routed (e.g., via a hot wire) to an electrical distribution board (also known and referred to as a “breaker box” or “breaker panel”) 208 generally located within or about the home 202. The electrical distribution board 208 may divide the received electricity between a plurality of circuits, each of which in turn transmit electricity to a respective one or more electric devices within, around, or generally near or about the home 202. In each of the plurality of circuits, a circuit breaker or fuse may protect against excess current at the circuit.

As depicted in FIG. 2, electricity may be transmitted via the electrical distribution board 208 to the electric devices 212a-212i about the home 202, the electric devices 212a-212i including an electric water heater, furnace, or HVAC 212a, an electrically powered vehicle 212b, a refrigerator 212c, a stove 212d, a lighting fixture 212e, a laundry washer 212f, and a dryer 212g. The electric devices 212a-212i may correspond to devices 110 of FIG. 1 in one embodiment. Further, devices about the home 202 may include an electrical outlet 212h, to which another one or more electric device, such as a television 212i, may be connected. The electric devices 212a-212i are only exemplary, and it should be understood that other electric devices (e.g., sensors, appliances, utility systems, electronics, etc.) may be among the electric devices about the home 202 receiving electricity via the electric distribution board 208. Further, it should be understood that, as used herein, electric devices about the home or structure are not limited to electric devices physically located within the interior of the home or other structure 202, but instead may additionally or alternatively include electric devices physically located outside of or generally around the home or other structure 202 (e.g., a porch light, an electric grill, garage door opener, etc.), wherein the electric devices are powered by electricity received via the electrical distribution board 208.

In operation, as one or more of the electric devices 212a-212i receive electricity via the electric distribution board 208, each device of the electric devices 212a-212i may be differentiated by an electrical signature that is unique to a respective device. In other words, transmission of electricity to the refrigerator 212c (and/or other electrical activity associated with the refrigerator 212c), for example, may be differentiated from transmission of electricity to the stove 212d. Furthermore, transmission of electricity to the television 212i via the electrical outlet 212h (and/or other electrical activity associated with the television 212i and/or outlet 212h), for example, may be differentiated from transmission of electricity to another recipient electric device (e.g., a cable box) via the same electrical outlet 212h.

An EM device 210, which may correspond to the EM device 170 of FIG. 1, may be affixed to or situated near the electrical distribution board 208. Generally, the EM device 210 may utilize the unique, differentiable electrical signatures of the electric devices 212a-212i by wirelessly (and/or via wired connection to the electrical distribution board) monitoring electrical activity including transmission of electricity via the electrical distribution board 208 to one or more of the electric devices 212a-212i. Monitoring of transmission of electricity to an electric device receiving the electricity may include, for example, monitoring (i) the time at which the electricity was transmitted, (ii) the duration for which the electricity was transmitted, and/or (iii) the magnitude of the electric current in the transmission.

Based upon the unique electrical signatures of the electric devices 212a-212i, the monitored electrical activity may be correlated with respective electric devices 212a-212i receiving the electricity transmitted via the electrical distribution board 208. Further, electrical activity associated with other components of the home's electrical system (e.g., the electrical distribution board 208 or wiring about the home 202) may be correlated with one or more electric devices to which the electrical activity also pertains. In some embodiments, the EM device 210 may perform the correlation and/or other functions described herein, via one or more processors of the EM device 210 that may execute instructions stored at one or more computer memories of the EM device 210.

In other embodiments, the electricity monitoring device 210 may monitor and record the electrical activity, and the correlation and/or other functions described herein may be performed at another system (e.g., a smart home controller such as controller 120 of FIG. 1 or an organization such as provider 130 of FIG. 1, which may correspond to an insurance system, a financial system, or a service system), which may receive datasets and/or signals indicative of monitored electricity and/or other data via one or more processors and/or through transfer via a physical medium (e.g., a USB drive).

In any case, correlation of the electrical activity with the respective electrical devices may produce datasets indicating, for example, the time, duration, and/or magnitude of electricity consumption by each of the electric devices 212a-212i during a period of electrical activity monitoring. As such, the datasets are indicative of electricity consumption detected from the EM device 210 and further processed by the EM device 210 and/or provider 130. If a washer or dryer is used more often than a television for example, the “severity” and/or “frequency” of use of the washer may appear as greater magnitudes of electricity consumption and/or greater duration of electricity consumption than those corresponding to television use.

Based upon at least the correlated electrical activity, a structure electrical profile may be built and stored at the EM device 210 and/or at some other system (e.g., a smart home controller, an insurance system, a financial system, a service system). The structure electrical profile may include, for each of the electric devices 212a-212i about the home 202, data indicative of operation of the respective electric device during at least the period at which the EM device 210 monitored electrical activity about the home 202.

Operation data regarding an electric device may include, for example, historical data indicating the electric device's past operation patterns or trends. For example, historical data may indicate a time of day, day of the week, time of the month, etc., at which an electric device frequently used electricity (e.g., a lighting fixture 212e may not use electricity during late night hours of the day). As another example, historical data may include the electric device's total electricity consumption or usage rate over a period of time.

Additionally or alternative, historical data may include data indicating past events regarding the electric device (e.g., breakdowns, power losses, arc faults, etc.). Additionally or alternatively, operation data regarding an electric device may include an expected electricity consumption or baseline electricity consumption for the electric device. For example, in the case of a refrigerator 212c, the refrigerator 212c's electricity consumption during a first period of monitoring may be reliably used to approximate an expected electricity consumption at a later time.

In some embodiments, the structure electrical profile may include data pertaining to the structure (e.g., home 202) as a whole. For example, the structure electrical profile may include data reflecting a total electricity or average usage rate over a period of time from the plurality of electric devices 212a-212i, collectively. As another example, the profile may include time-of-day, day-of-week, etc., data reflecting times at which the home 202 as a whole uses more or less electricity. In some embodiments, the structure electrical profile may include a digital “map” of the home 202. A home map may indicate spatial locations of the electric devices 212a-212i, and/or spatial relationships between two or more of the electric devices 212a-212i. Additionally or alternatively, the home map may indicate which of the electric devices 212a-212i are connected to each electrical circuit within the electrical system of the home 202.

In some embodiments, the home map may be configurable by a user (e.g., a homeowner of the home 202). The user may, for example, configure the map via an I/O module (e.g., screen, keypad, mouse, voice control, etc.) of the EM device 210, or via an I/O module of another computing device, which may transmit the home map to the EM device 210. Additionally or alternatively, the home map may be stored at one or more computer memories of another system (e.g., provider 130, or a smart home controller).

In some embodiments, the system 200 may include one or more smart components. For example, a smart home controller, which may correspond to controller 120 of FIG. 1, may be present about the home 202, and at least one of the electric devices within the home may be a smart device (e.g., a smart appliance or a smart vehicle). The smart home controller may further be in communication with one or more sensors that may be located on or otherwise associated with electric devices and/or other fixtures about the home 202. Such sensors and smart devices may transmit to the smart home controller data (e.g., usage data, error signals, telematics, etc.) that, alone or combined with the functions of the EM device 210 discussed herein, may produce further indication of electrical activity about the home 202. The smart home controller may be configured for wireless communication with each sensor and/or associated item interconnected with a smart home system or wireless network (e.g., the system 100 of FIG. 1). In some embodiments, the EM device 210 may receive data (e.g., usage data, error signals, telematics, etc.) from the smart home controller, and incorporate such data into generating its structure electrical profiles.

Accordingly, the structure electrical profile may be built additionally based upon telematics data associated with the home 202. Telematics data may include, for example, (i) home telematics data (e.g., appliance usage data) received from smart devices and/or sensors, (ii) vehicle telematics data received from a smart and/or autonomous vehicle, (iii) mobile device telematics data (e.g., positioning data) received from a mobile device associated with an occupant of the home 202, and/or (iv) any other telematics data described herein, particularly with regard to FIG. 1. Telematics data may be received at the EM device 210 and/or at some other system (e.g., provider 130) that builds the structure electrical profile. The telematics data described herein may include, inter alia, image, audio, infrared, sensor, and/or GPS data.

Additionally or alternatively, the structure electrical profile may be built based upon positioning (e.g., GPS) data from a mobile device of a party associated with the home 202. For example, the structure electrical profile may be built to indicate historical electrical activity and/or expected future electrical activity based upon whether the party is within the home 202.

As will be further described herein, provider 130 may leverage the structure electrical profile and/or data from the EM device 210 and/or smart home controller with other data (e.g., claims data) to develop electric device usage-based risk profiles, and/or associated UBI products. The usage-based risk profiles may be developed by generating a claim risk profile having a risk defined by the provider 130 and generating a correlation rule specifying one or more parameters that indicate which portion of the datasets as indicated in the structure electrical profile, when compared to the claim risk profile, exceed a minimum level of the risk. As such, the provider 130 may receive (such as via wireless communication or data transmission over one or more radio links or communication channels) the datasets from the smart home controller and/or EM device 210.

The system 200 may include additional, fewer, or alternate components and functionality, including the components and functionality discussed elsewhere herein. Further, one or more components of the system 200 may be similar or identical components to analogous components illustrated and described with regard to FIG. 1. In other words, the functionality of the system 200 described herein may be combined with the functionalities of the system 100 of FIG. 1.

### Exemplary EF Dataset

FIG. 3 illustrates a block diagram of an exemplary Electricity Flow (EF) dataset 300 indicative of the electricity consumption from electric device 212 detected by EM device 210 in accordance with one aspect of the present disclosure. The electricity consumption as used herein can also be described as electricity usage and/or electricity flow that is detected by EM device 210 as a result of usage of electric device 212. For ease of illustration, although the EF dataset 300 will be described for a dataset produced in response to electrical activity from a stove, it should be appreciated that the EF dataset produced may be in response to any of the electric devices 212a-212i described herein. It should also be appreciated that the EF dataset 300 may include additional, fewer, or alternate data portions.

In some embodiments, as shown, the EF dataset 300 may include an account portion 302 that identifies the particular structure electrical profile created by the EM device 210 associated with property 105, the property 105, a user's profile account associated with the provider 130, etc. Similarly, in some embodiments, as shown, the EF dataset 300 may include a device identifier portion 304, which may include a serial number, model number, brand, or other identifier specific to the device 212 (e.g., stove). By including the account portion 302 and/or device identifier portion 304 in the EF dataset 300, the provider 130 may retrieve the desired particular structure electrical profile from the EF dataset identified by the account portion 302 or device identifier portion 304. For example, the provider 130 may request the particular EF dataset for the stove by transmitting a request with the portion (e.g., 302, 304) that identifies the stove to the controller 120 and/or EM device 210. The controller 120 and/or EM device 210 may search for the datasets or profiles keyed to the requested portion, and subsequently send the datasets or profiles having the requested portions to the provider 130.

In some embodiments, as shown, the EF dataset 300 may include a frequency portion 306 and/or a severity portion 308. The frequency portion 306 may include electrical usage data pertaining to how frequently the stove was in use, such as daily, weekly, or monthly. The severity portion 308 may include electrical usage data pertaining to how intensely the stove was in use, such as the number of minutes or hours in a day, week, or month, or the mean, median, or mode of the temperature that the stove was set to while in use. Accordingly, EF datasets may indicate the time, duration, and/or magnitude of electricity consumption for the stove during a period of electrical activity monitoring. Availability of both portions may suggest that a stove was used daily, and that the stove was used for longer periods of time from 6 pm-7 pm (e.g., for dinner preparation) when compared to usage from Sam-9 am (e.g., for breakfast preparation), for example. Over time, the frequency portion 306 and/or a severity portion 308 detected by the EM device 210 may indicate patterns or trends of operational usage of the stove.

In some embodiments, as shown, the EF dataset 300 may include a replacement portion 310, which indicates information for upgrading or replacing the electronic or electric device identified in device identifier portion 304. Replacement portion 310 may contain descriptions of replacement or upgrade devices (e.g., brand, model, serial number, ratings), price of the replacement or upgrade devices, replacement or upgrade compatibility information, vendors that sell the replacement or upgrade devices, etc.

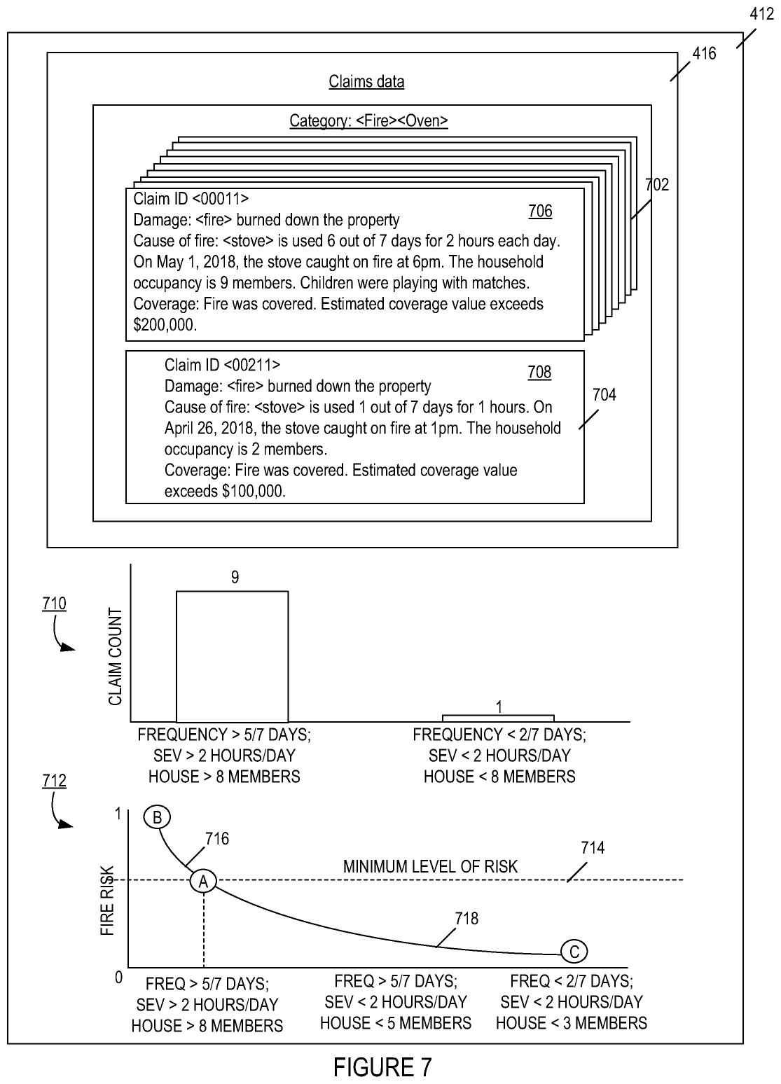

In some embodiments, as shown, the EF dataset 300 may include a home occupancy portion 312, which indicates the household size or occupancy (e.g., 9) of the home or whether the household includes children under a predefined age (e.g., 3 years old). The home occupancy portion 312 may be based upon auto insurance information covering a vehicle 212b of a homeowner associated with the property 105 that lists the number of people covered. As will be shown with respect to FIG. 7 below, home occupancy may be a parameter specified by a correlation rule.

### Exemplary Risk Correlation Engine

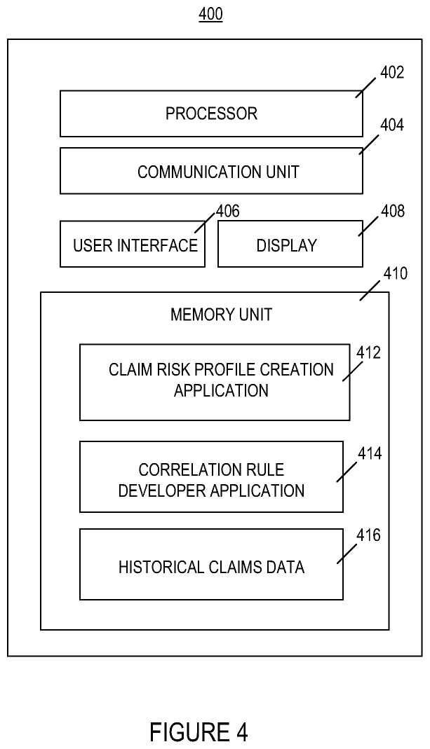

FIG. 4 illustrates a block diagram of an exemplary risk correlation (RC) engine 400 in accordance with one aspect of the present disclosure. In one embodiment, RC engine 400 may include a processor 402, a communication unit 404, a user interface 406, a display 408, and a memory unit 410. RC engine 400 may include additional, fewer, or alternate components, including those discussed elsewhere herein.

RC engine 400 may be implemented as any suitable computing device. In various aspects, RC engine 400 may be implemented within or as part of a server, a desktop computer, etc. In one aspect, RC engine 400 may be an implementation of provider 130, as shown and discussed with reference to FIG. 1.

Communication unit 404 may be configured to facilitate data communications between RC engine 400 and one or more components of a local organization network (e.g., local organization network 115, as shown in FIG. 1) and/or other internal or external networks. Communication unit 404 may be configured to facilitate communications between one or more networks and/or network components in accordance with any suitable number and/or type of communication protocols, which may be the same communication protocols as one another or different communication protocols based upon the particular network component and/or network that RC engine 400 is communicating with.

In the present aspects, communication unit 404 may be implemented with any suitable combination of hardware and/or software to facilitate this functionality. For example, communication unit 404 may be implemented with any suitable number of wired and/or wireless transceivers, network interfaces, physical layers (PHY), ports, etc. Communication unit 404 may enable communications between RC engine 400 and one or more network components and/or networks, such as one or more network components included in local organization network 115, for example, as previously discussed with reference to FIG. 1.

Communication unit 404 may send and/or receive data in accordance with one or more applications (e.g., web-based applications) hosted on RC engine 400, and may facilitate data communications between RC engine 400 and one or more devices (e.g., EM device 210, controller 120) to support the functionality of such hosted applications. For example, communication unit 404 may send data that enables one of more devices and/or network components to display one or more prompts, options, and/or selections in accordance with such applications, thereby allowing users to specify, for example, parameters for generating a claim risk profile including a defined risk corresponding to historical electricity consumption information. As will be described further herein, claim risk profile creation application 412 may be executed by processor 402 to cause processor 402 to generate the claim risk profile, and/or store the claim risk profile in memory unit 410. Further, the one or more prompts, options, and/or selections may allow users to specify, for example, parameters for generating a correlation rule for identifying which portion of the datasets (e.g., EF dataset 300) when compared to the claim risk profile exceeds a minimum level of the risk.

As will be described further herein, correlation rule developer application 414 may be executed by processor 402 to cause processor 402 to generate the correlation rule and/or store the correlation rule in memory unit 410.

Furthermore, communication unit 404 may be configured to receive data from one or more devices such as user selections and answers to prompts including, for example, the aforementioned parameters. The received parameters and/or other data received from other computing devices and/or network components may then be stored in any suitable portion of memory unit 410, for example. This data may be accessible and available to the various software applications stored on memory unit 410 and executed by processor 402 such that the various functions of the embodiments as described herein may be carried out as needed.

User interface 406 may be configured to allow a user to interact with RC engine 400. For example, user interface 406 may include a user-input device such as an interactive portion of display 408 (e.g., a “soft” keyboard displayed on display 408), an external hardware keyboard configured to communicate with RC engine 400 via a wired or a wireless connection, one or more keyboards, keypads, an external mouse, or any other suitable user-input device.

Display 408 may be implemented as any suitable type of display and may facilitate user interaction with RC engine 400 in conjunction with user interface 406. For example, display 408 may be implemented as a capacitive touch screen display, a resistive touch screen display, etc. In various embodiments, display 408 may be configured to work in conjunction with processor 402 and/or user interface 406 to display various prompts, selections, etc., such as those with respect to parameters utilized by RC engine 400, which are received via user interface 406 and stored in any suitable portion of the memory unit 410, as discussed above.

Processor 402 may be implemented as any suitable type and/or number of processors, such as a host processor for the relevant device in which RC engine 400 is implemented, for example. Processor 402 may be configured to communicate with one or more of communication unit 404, user interface 406, display 408, and/or memory unit 410 to send data to and/or to receive data from one or more of these components.

For example, processor 402 may be configured to communicate with memory unit 410 to store data to and/or to read data from memory unit 410. In accordance with various aspects, memory unit 410 may be a computer-readable non-transitory storage device, and may include any combination of volatile (e.g., a random access memory (RAM)), or a non-volatile memory (e.g., battery-backed RAM, FLASH, etc.). In one embodiment, memory unit 410 may be configured to store instructions executable by processor 402. These instructions may include machine readable instructions that, when executed by processor 402, cause processor 402 to perform various processes.

Each of the claim risk profile creation application 412 and correlation rule developer application 414 may be a portion of memory unit 410 that is configured to store instructions that, when executed by processor 402, cause processor 402 to execute one or more supporting algorithms or modules. The functionality discussed herein with reference to claim risk profile creation application 412 and correlation rule developer application 414 may be facilitated by any suitable combination of computing devices. For example, in some embodiments, claim risk profile creation application 412 and correlation rule developer application 414 (and one or more modules thereof) may be stored and executed on RC engine 400. However, in other embodiments, claim risk profile creation application 412 and correlation rule developer application 414 (and one or more modules thereof) may be stored and/or executed on a separate computing device, which is used to access RC engine 400 to facilitate the same functionality as if claim risk profile creation application 412 and correlation rule developer application 414 had been executed locally via RC engine 400.

The functions and the result of the execution of claim risk profile creation application 412 and correlation rule developer application 414 are further discussed in detail below. It should be noted that although FIG. 4 depicts claim risk profile creation application 412 and correlation rule developer application 414 as separate applications, it should be appreciated that one application may be envisioned to incorporate the programming of both the claim risk profile creation application 412 and correlation rule developer application 414.

### Claim Risk Profile Creation Application

In one embodiment, the claim risk profile creation application 412 may be a portion of memory unit 410 configured to store instructions that, when executed by processor 402, cause processor 402 to generate a claim risk profile including a pre-defined risk corresponding to historical electricity consumption information. To do so, the processor 402 may first retrieve historical claims data 416 stored in memory unit 410 in some embodiments if the provider 130 manages its own claims data 416. In other embodiments, the claims data 416 may be retrieved from other data sources, such as a public or commercial data source (e.g., insurance providers). A public data source may provide claims data 416 scrubbed of personal information, or otherwise de-identified the claim data. A commercial data source may provide claims data 416 that has not been scrubbed of personal information, or otherwise de-identified the claim data.

In any event, the historical claims data 416, which may include homeowners insurance claim data and/or other data (e.g., mobile device data, telematics data), may provide contextual information as to property damage (e.g., a fire, damages caused by theft or other break-ins), causes to the damage (e.g., stove was kept on, unlocked door allowed an intruder to come in), and additional information (e.g., claim ID unique to the claim, a policy owner ID unique to the policy holder who filed the claim, a property ID unique to the property owned by the policy holder, extent of personal injuries resulting from a property damage, data indicating an extent of liability damages resulting from the property damage, dates and times of property damage, duration of how long a device has been on or off, repair and/or replacement costs and/or estimates). The claims data may be organized by category, such as based upon the property damage type (e.g., fire) and cause type (e.g., stove).

Historical claims data 416 may be associated with actual insurance claims arising from real world property damage, such as data scrubbed of personal information, or otherwise de-identified home insurance claim data. Historical claims data 416 generally represents insurance claims filed by home insurance policy owners. In one embodiment, actual claim images (such as mobile device images of damaged homes or devices) may be analyzed to associate an amount of physical damage shown in one or more images of the home with a repair or replacement cost of the home or objects within the home. The actual claim images may be used to estimate repair or replacement cost.

The processor 402 may then process (e.g., read, scan, parse) and/or analyze the historical claims data 416 to generate a claim risk profile for a particular type of property damage (e.g., fire, theft). To do so particularly, the processor 402 may execute claim risk profile creation application 412 to (i) sort the historical claims data 416 by type of property damage, such as by using a keyword detection technique to recognize certain mark-ups in the historical claims data 416 (e.g., <fire>, <intruder>), (ii) select a type of property damage (e.g., <fire>) to assess a risk for, (iii) identify historical electricity consumption information for the selected type of property damage, and (iv) generate a claim risk profile for a particular type of property damage based upon the identified historical electricity consumption information for the selected type of property damage.

In some embodiments, to generate the claim risk profile, the processor 402 may execute claim risk profile creation application 412 to first sort the historical claims data 416 corresponding to the selected type of property damage into at least two groups, each group having a common set of characteristics. As each group may have an expected electricity consumption characteristic, the historical claims data 416 may accordingly be sorted based upon “best fit” techniques into the at least two groups. The processor 402 may then count the number of claims in each of the at least two groups. The processor 402 may then divide the count total of each group by the total count of all the groups. Lastly, the processor 402 may normalize the relative score of each group corresponding to the respective electricity consumption information to calculate risk for each group having the common and distinct set of characteristics.

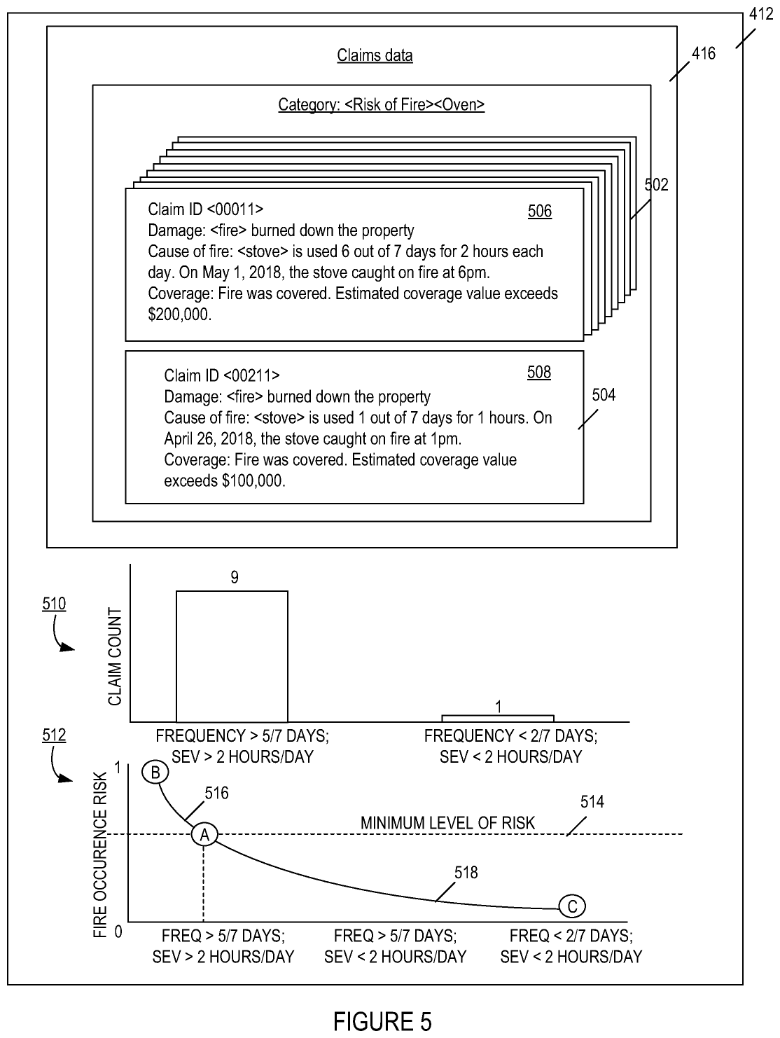

For example, as shown in FIG. 5, the processor 402 may, via the claim risk profile creation application 412, first sort the historical claims data 416 corresponding to fire damage into at least two groups, groups 502 and 504. Group 502 may have an expected electricity consumption characteristic (i.e., stove used 5 out of 7 days for more than 2 hours each day), and group 504 may have a different expected electricity consumption characteristic (i.e., stove used 2 out of 7 days for less than 2 hours each day). The historical claims data 416 may accordingly be sorted based upon “best fit” techniques into the at least two groups. Claims 506 (and 8 other similar claims) may be sorted into group 502, and claim 508 may be sorted into group 504. The processor 402 may then count the number of claims in each of the at least two groups.

As shown in graph 510, the processor 402 may then count 9 total claims in group 502 and 1 total claim in group 504. To calculate a relative score, the processor 402 may divide the count total of each group by the total count of all the groups. Here, the processor 402 may divide 9 by 10 to determine a relative score of 90% for group 502. Similarly, the processor 402 may divide 1 by 10 to determine a relative score of 10% for group 504. Lastly, as shown in graph 512, the processor 402 may normalize the relative score of each group corresponding to the respective electricity consumption information to calculate risk for each group having the common and distinct set of characteristics.

Although the historical claims data 416 may indicate a total number of claims on the order of several hundreds of thousands, a sample total of 10 historical claims is assumed in this example for purposes of brevity and ease of illustration. Further, the relative score may be calculated in accordance with any suitable scaled numeric system that indicates a likelihood of fire damage occurring for a given set of historical claims data 416.

In one embodiment, a user may create one or more claim risk profiles via a manual process. The claim risk profile creation application 412, when executed by processor 402, may facilitate instructions to be communicated to a suitable computing device that is utilized by the user in accordance with a manual claim risk profile creation process. For example, if a user is generating the claim risk profile manually at RC engine 400, then claim risk profile creation application 412 may facilitate instructions to be displayed via display 408. To provide another example, if a user is using a computer that is communicatively coupled to RC engine 400 to manually generate one or more claim risk profiles, then claim risk profile creation application 412 may facilitate interaction between the remote computing device and RC engine 400 such that RC engine 400 may receive and store each generated claim risk profile in a location that is accessible by RC engine 400.

Additionally or alternatively, claim risk profile creation application 412 may, when executed by processor 402, partially or completely automate the process of generating claim risk profiles. For example, a user may configure the claim risk profile creation application 412 or another application to build a process for analyzing claims data 416 that automatically generates claim risk profiles from the analysis. This process may be semi-automated or fully automated by the claim risk profile creation application 412, generating new claim risk profiles or updating existing claim risk profiles with little or no user intervention.

In various embodiments, claim risk profile creation application 412 may, when executed by processor 402, allow for new claim risk profiles to be added to the existing pool of stored claim risk profiles. Additionally or alternatively, when a new claim risk profile that is not stored among a current pool of claim risk profiles is identified, claim risk profile creation application 412 may facilitate a message being displayed, a notification being sent, instructions being displayed, etc. These instructions, messages, etc., may allow a user to manually approve the new claim risk profile and to store the new claim risk profile with the existing claim risk profiles in the same manner that was done to build the initial pool of claim risk profiles.

In various embodiments, claim risk profile creation application 412 may, when executed by processor 402, allow for existing claim risk profiles to be modified as new claims data are added to historical claims data 416.

### Correlation Rule Developer Application

In one embodiment, the correlation rule developer application 414 may be a portion of memory unit 410 configured to store instructions that, when executed by processor 402, cause processor 402 to generate a correlation rule specifying one or more parameters that indicate which portion of the datasets received from EM device 210 or controller 120, when compared to the one or more of the claim risk profiles, exceed a minimum level of the risk.

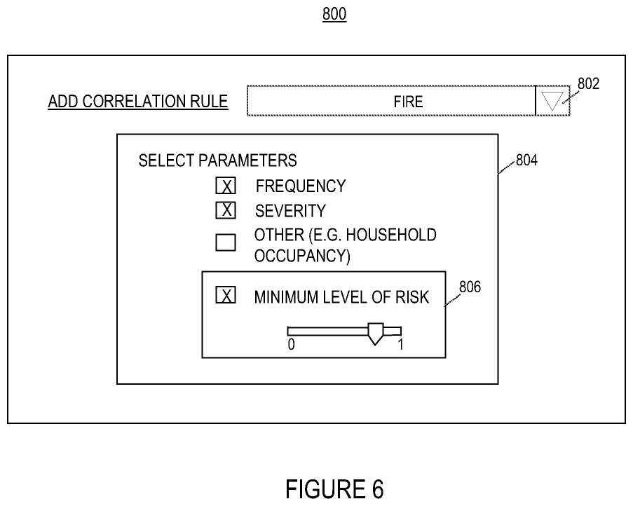

To provide an illustrative example, FIG. 6 illustrates a graphical interface 600 corresponding to the correlation rule developer application 414. A user may utilize the graphical interface 600 to generate a correlation rule. The graphical interface 600 may include field 602 where a user may input the type of damage for which the correlation rule is generated. As shown, for example, selection of the type of damage as “fire” may align the correlation rule to compare datasets received from EM device 210 or controller 120 to risk profile 512 for fire damage as shown in FIG. 5. Further, graphical interface 600 may include field 604 where a user may input the parameters for which the correlation rule is generated.

The selected parameters as shown in FIG. 6 may configure the processor 402 to compare both the actual frequency and severity portions of the dataset 300 to the expected frequency and severity portions of the expected electricity consumption characteristic of the risk profile. For example, if the actual frequency and severity portions of the dataset 300 indicated that a particular household uses the stove more than 5 days out of the week and more than 2 hours each day, the processor 402 may compare both the actual frequency and severity portions to the expected frequency and severity portions of the expected electricity consumption characteristic along the x-axis of the fire risk profile 512 to find the expected frequency and severity portions that closest match the actual frequency and severity portions, and determine that the risk of a fire starting in the household for dataset 300 corresponding to the closest matched expected frequency and severity portions of the risk profile 512 corresponds to a value of 0.7 (i.e., 70% likely), as shown at point 516.

Using the same example, had the “severity” parameter only been selected in field 604, the processor 402 may compare the actual severity portion (i.e., not the actual frequency portion) to the expected severity portion (i.e., not the expected frequency portion) of the expected electricity consumption characteristic along the x-axis of the fire risk profile 512 to find the expected frequency and severity portions that closest match the actual frequency and severity portions, and determine that the risk of a fire starting in the household for dataset 300 corresponding to the closest matched expected frequency and severity portions of the risk profile 512 corresponds to a range of values between 0.2 (i.e., 20% likely) and 0.7 (i.e., 70% likely), as shown by the range between points 518 and 516 on the curve. In such situations, to obtain a more accurate risk, other parameters may be contemplated, such as the frequency portion.

For instance, as shown in FIG. 7, the processor 402 may, via the claim risk profile creation application 412, sort historical claims data 416 corresponding to fire damage into groups 702 and 704. Group 702 may have an expected electricity consumption characteristic (i.e., stove used 5 out of 7 days for more than 2 hours each day in a household with 9 members, among them children), and group 704 may have a different expected electricity consumption characteristic (i.e., stove used 2 out of 7 days for less than 2 hours each day in a household with 2 members, none of them children). After determining graphs 710 and 712 in similar fashion as graphs 510 and 512, the processor 402 may identify the risk profile 712 for fire damage.

If the dataset 300 includes a home occupancy portion 312 that indicates the household size or occupancy (e.g., 9) of the home or whether the household includes children under a predefined age (e.g., 3 years old), and home occupancy was selected in field 604, the processor 402 may compare the actual severity portion (i.e., not the actual frequency portion) and the actual home occupancy portion to the expected severity portion (i.e., not the expected frequency portion) and the expected home occupancy portion of the expected electricity consumption characteristic to find the expected frequency and severity portions that closest match the actual frequency and severity portions, and determine that the risk of a fire starting in the household of 9 for dataset 300 corresponding to the closest matched expected frequency and severity portions of the risk profile 712 corresponds to a value of 0.7 (i.e., 70% likely), as shown at point 716.

Turning back to FIG. 6, graphical interface 600 may further include field 606 where a user may input the minimum level of the risk for which the correlation rule is generated. The selected minimum level of the risk, which may correspond to lines 514 and 714 of risk profiles 512 and 712 for fire damage in FIGS. 5 and 7, respectively, may configure the processor 402 to identify the datasets that correspond to the minimum level of the risk (or above) as specified by the correlation rule. Accordingly, the selection in field 606 made as illustrated in FIG. 6 may configure the processor 402 to identify qualified datasets that meet or exceed the specified minimum level of the risk (i.e., correspond to a risk between points A and B on the curve in FIGS. 5 and 7). One of ordinary skill in the art will understand that additional or less fields having different arrangements and types of fields than the ones described above may be contemplated.

Accordingly, the processor 402 of RC engine 400 may, via execution of correlation rule developer application 414 or another application (not shown) dedicated to assessing dataset 300 against claim risk profiles in accordance with a correlation rule, identify or “flag” the dataset 300 as a “qualified” dataset upon detecting that the dataset 300 contains risk that meets or exceeds the minimum level of the risk in accordance with the one or more parameters specified by the correlation rule. Upon identifying the dataset 300 as a “qualified” dataset, the RC engine 400 may extract the account portion 302 that identifies the particular structure electrical profile created by the EM device 210 associated with property 105 and perform a particular action on behalf of the customer associated with the EM device 210 or property 105. Generally, the RC engine 400 may identify ways to lower risk (i.e., lower the risk identified between points A and B to a risk below the minimum level of the risk identified between points A and C, as shown in FIGS. 5 and 7) corresponding to the electricity usage of the stove. Of course, if the dataset 300 is not identified as a “qualified” dataset, the processor 402 may maintain the status quo of the user policy or user behavior profile or even generate rewards for rewarding low risk behavior, for example. Particularly, the RC engine 400 via processor 402 may dynamically update one or more terms of a user policy for any property 105 exhibiting electricity consumption information corresponding to a qualified dataset, in some embodiments.

In another embodiment, the processor 402 may dynamically update a usage behavior profile for any property 105 exhibiting electricity consumption information corresponding to a qualified dataset with a recommendation for upgrading or replacing the stove. In another embodiment, the processor 402 may dynamically update a usage behavior profile for any property 105 exhibiting electricity consumption information corresponding to a qualified dataset with a service recommendation for adjusting the electricity consumption for the stove. Each will be described in turn further below.

### Exemplary Method for Evaluating Usage of Individual Electric or Electronic Devices

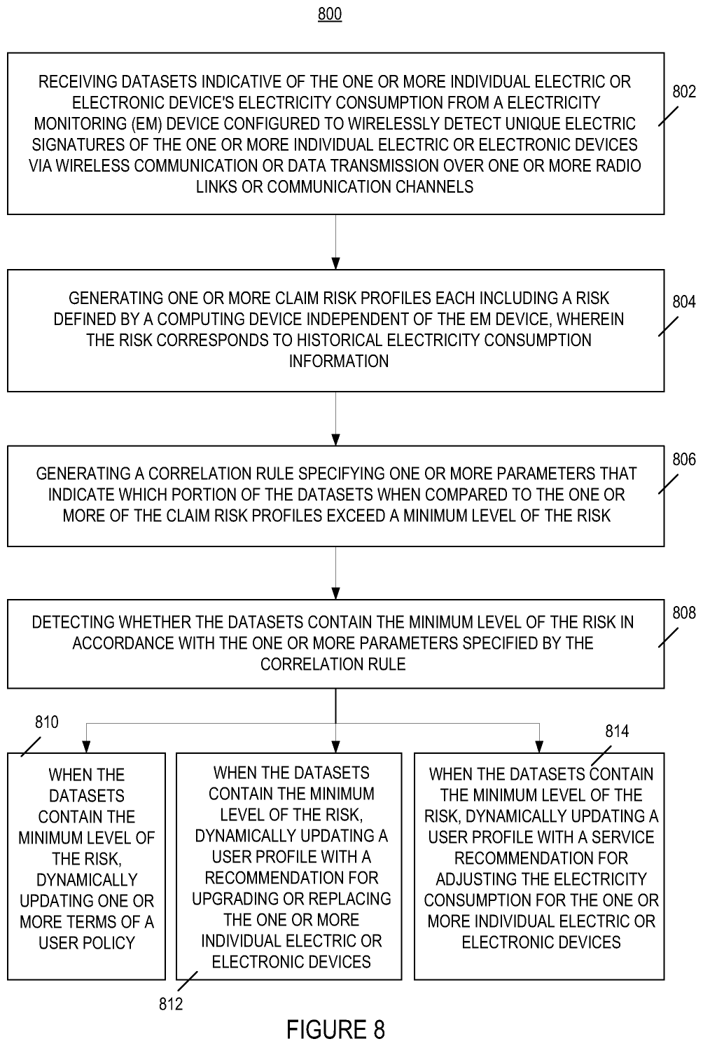

FIG. 8 illustrates an exemplary method 800 for evaluating usage of one or more individual electric or electronic devices powered via an electrical system of a home in accordance with an exemplary aspect of the present disclosure. In the present aspect, method 800 may be implemented by any suitable computing device (e.g., provider 130, as shown in FIG. 1, RC engine 400, as shown in FIG. 4, etc.). In one aspect, method 800 may be performed by one or more processors, applications, and/or routines, such as processor 402 executing claim risk profile creation application 412, correlation rule developer application 414, and/or instructions stored in memory unit 410, for example, as shown in FIG. 4. In some embodiments, the provider 130 and/or RC engine 400 may be part of an insurance provider, financial provider, and/or service provider (or facilitate communications with an insurance, financial, and/or service provider), and as such, may access databases as needed to perform related functions.

Method 800 may begin by receiving datasets indicative of the one or more individual electric or electronic devices' electricity consumption from an EM device (block 802). The EM device may be configured to wirelessly detect unique electric signatures of the one or more individual electric or electronic devices via wireless communication or data transmission over one or more radio links or communication channels. Such datasets, such as dataset 300, may contain a plurality of portions as shown in FIG. 3.

As disclosed herein, such portions may be described as “actual” portions of dataset for a particular home (e.g., home 202) to differentiate portions of datasets from “expected” portions that refer to common sets of characteristics found upon analyzing historical electricity consumption information across a plurality of homes. For example, as shown in the risk profile 512 of FIG. 5, “expected” portions may refer to an expected frequency portion (e.g., greater than 5 of 7 days) and an expected severity portion (e.g., greater than 2 hours per day) upon analyzing historical claims 506 and 508 collected from a plurality of households having property distinct from property 105. “Actual” portions refer to actual frequency portion (e.g., field 306) and actual severity portion (e.g., field 308) determined from electrical activity for property 105 associated with dataset 300.

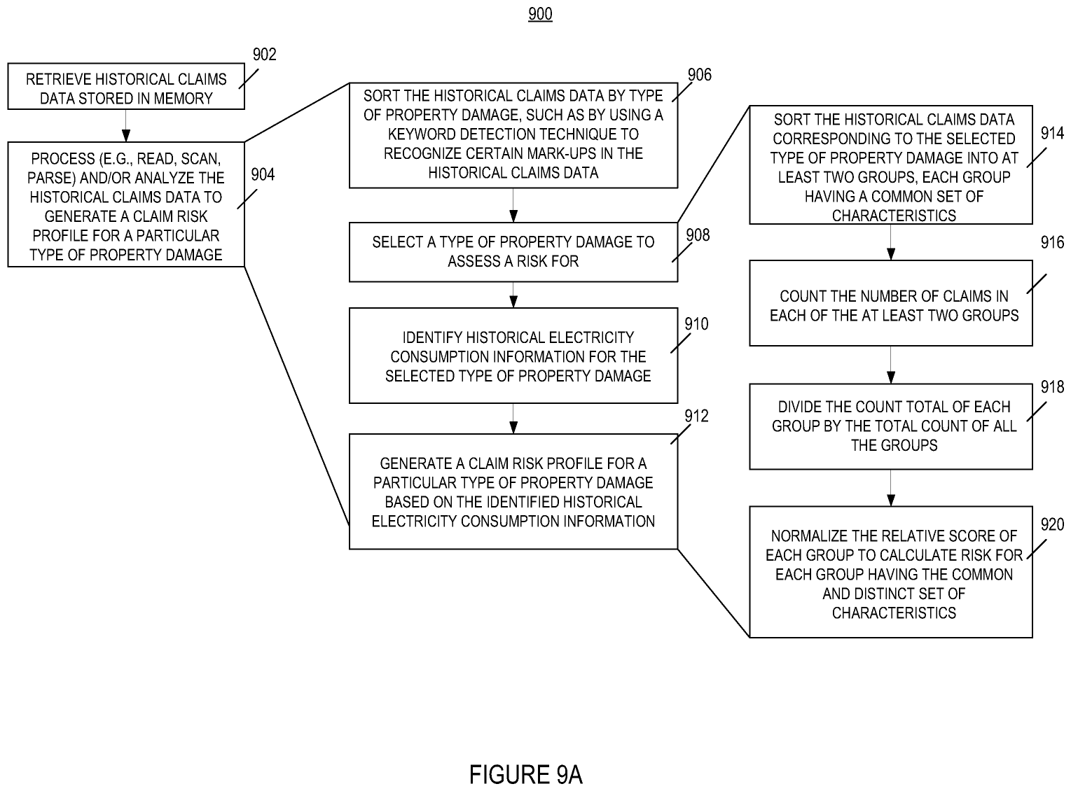

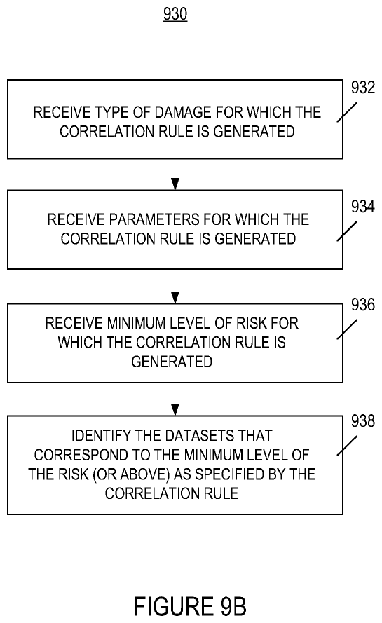

Method 800 may proceed by generating one or more claim risk profiles, each including a risk defined by a computing device independent of the EM device, wherein the risk corresponds to historical electricity consumption information (block 804). The computing device may refer to the provider 130, or a third party device associated with a public or commercial data source. Because the EM device may be specific to a household of property 105, the EM device may be unable to collect historical electricity consumption information from other households, but the computing device may have access to historical claims data, in some embodiments. Examples of claim risk profiles include fire risk profiles 512 and 712 of FIGS. 5 and 7. Further details of block 804 are described with respect to FIG. 9A.

Method 800 may proceed by generating a correlation rule specifying one or more parameters that indicate which portion of the datasets when compared to the one or more of the claim risk profiles exceed a minimum level of the risk (block 806). The specified parameters may control which “actual” portions of the datasets are compared to the “expected” portions of the claim risk profiles generated in block 804. Further details of block 806 are described with respect to FIG. 9B.

Method 800 may proceed by detecting whether the datasets contain the minimum level of the risk in accordance with the one or more parameters specified by the correlation rule (block 808). The minimum level of the risk may control which datasets are qualified as high risk (i.e., above a minimum level of the risk). For example, dataset 300 for property 105 that includes a frequency portion 306 and severity portion 308 indicating that a stove is used every day in a week for more than 2 hours each day, respectively, when compared to fire risk profile 512, may demonstrate that a fire is likely to occur at property 105.

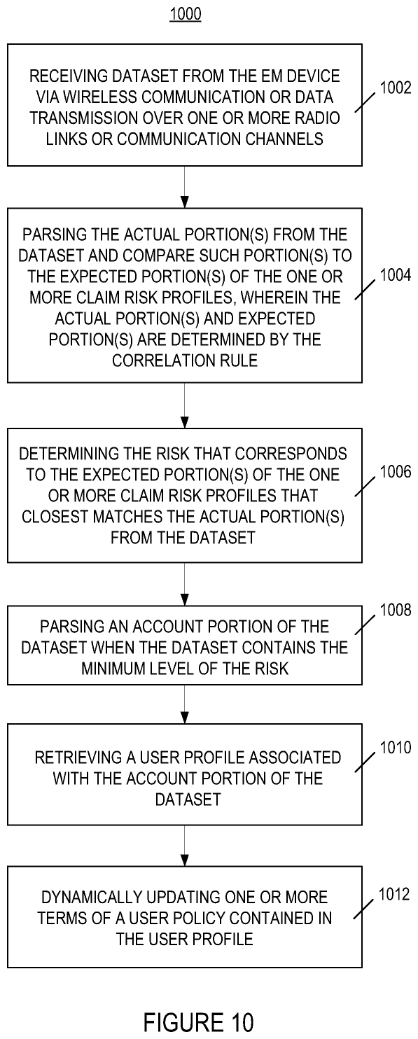

In some embodiments, method 800 may proceed by dynamically updating, by the one or more processors, one or more terms of a user policy when the datasets contain the minimum level of the risk (block 810). In the immediately aforementioned example, because the household of property 105 is exhibiting risky behavior (i.e., as evidenced by the dataset 300 having a risk above the minimum level of the risk defined in the risk profile), homeowner insurance premiums may increase for the household. The higher premiums may be communicated to the customer of property 105, and may incentive the household to adjust usage of the stove, thereby lowering risk of a fire. Further details of block 810 are described with respect to FIG. 10.

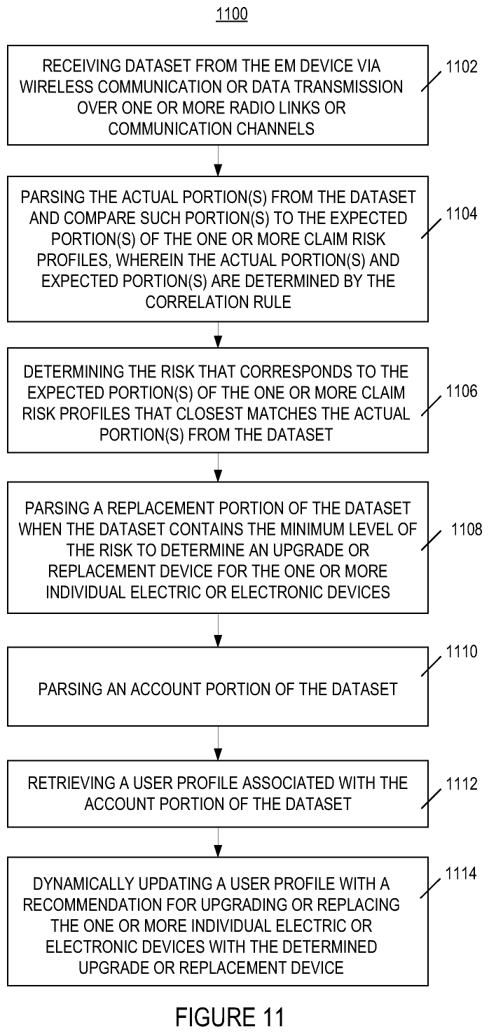

In other embodiments, method 800 may proceed, from block 808, by dynamically updating, by the one or more processors, a user profile with a recommendation for upgrading or replacing the one or more individual electric or electronic devices when the datasets contain the minimum level of the risk (block 812). In the immediately aforementioned example, because the household of property 105 is exhibiting risky behavior, a recommendation for a more energy-efficient stove, or a stove with more safety functions than the existing stove, may be provided. The recommendation may be communicated to the customer of property 105, and may incentive the household to upgrade or replace the existing stove with the recommended stove, thereby lowering risk of a fire. Further details of block 812 are described with respect to FIG. 11.

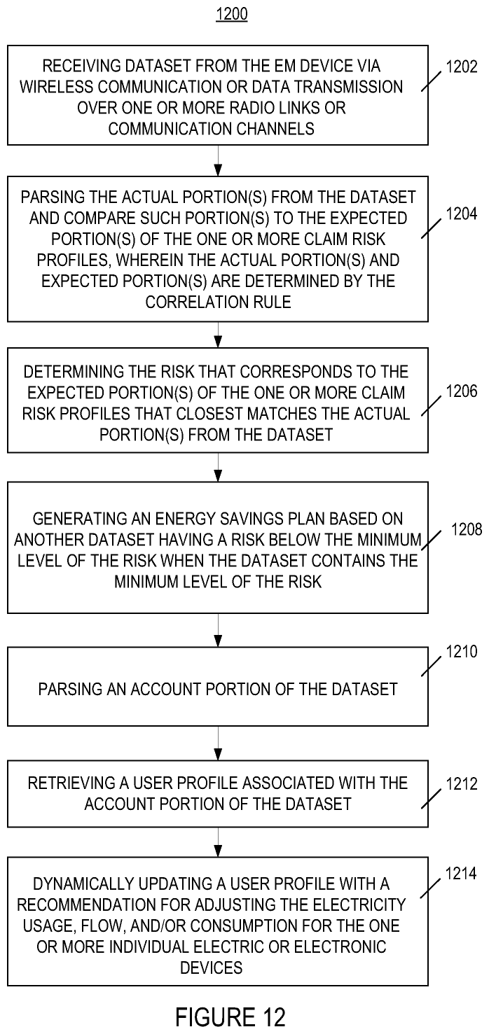

In yet other embodiments, method 800 may proceed, from block 808, by dynamically updating, by the one or more processors, a user profile with a service recommendation for adjusting the electricity consumption for the one or more individual electric or electronic devices when the datasets contain the minimum level of the risk (block 814). In the immediately aforementioned example, because the household of property 105 is exhibiting risky behavior, a service recommendation including ways to cut down on usage of the stove may be provided. The service recommendation may be communicated to the household, and may incentive the household to adopt cutting down usage of the stove, thereby lowering risk of a fire. Further details of block 814 are described with respect to FIG. 12.

The method 800 may include additional, less, or alternate actions, including those discussed elsewhere herein. It should also be contemplated that provider 130 may perform any or all of the actions described in blocks 810, 812, and 814.

### Exemplary Method for Generating a Claim Risk Profile

FIG. 9A illustrates an exemplary method 900 for generating a claim risk profile in accordance with an exemplary aspect of the present disclosure. In the present aspect, method 900 may be implemented by any suitable computing device (e.g., provider 130, as shown in FIG. 1, RC engine 400, as shown in FIG. 4, etc.). In one aspect, method 900 may be performed by one or more processors, applications, and/or routines, such as processor 402 executing claim risk profile creation application 412, and/or instructions stored in memory unit 410, for example, as shown in FIG. 4. In some embodiments, the provider 130 and/or RC engine 400 may be part of an insurance provider, financial provider, and/or service provider (or facilitate communications with an insurance, financial, and/or service provider), and as such, may access databases as needed to perform related functions.

Method 900 may begin by retrieving historical claims data stored in memory (block 902). For example, the processor 402 may retrieve historical claims data 416 stored in memory unit 410 or from memory devices of other data sources, such as a public or commercial data source (e.g., insurance providers).

Method 900 may proceed by processing (e.g., reading, scanning, parsing) and/or analyzing the historical claims data to generate a claim risk profile for a particular type of property damage (e.g., fire, theft) (block 904). For example, the processor 402 may execute claim risk profile creation application 412 to process and/or analyze the historical claims data 416 to generate a fire risk profile 512 for a particular type of property damage (e.g., fire).

To perform the step described in block 904, the method 900 may proceed by sorting the historical claims data by type of property damage, such as by using a keyword detection technique to recognize certain mark-ups in the historical claims data (block 906), selecting a type of property damage to assess a risk for (block 908), identifying historical electricity consumption information for the selected type of property damage (block 910), and generating a claim risk profile for a particular type of property damage based upon the identified historical electricity consumption information for the selected type of property damage a risk profile (block 912).

In some embodiments, when the method 900 proceeds to identify historical electricity consumption information for the selected type of property damage, as shown in block 910, the range of electricity consumption information may be divided into at least two groups. For example, upon identifying historical electricity consumption information for a fire started in a home, it may be determined that a first group of claims 502 shows a pattern of frequent use of a stove that likely causes a fire, whereas a second group of claims 504 shows that it was simply an accident (i.e., not the frequent use of a stove), as shown in FIG. 5. Accordingly, upon selecting a type of property damage to assess a risk for as shown in block 908, the method 900 may proceed to sort the historical claims data corresponding to the selected type of property damage into at least two groups, each group having a common set of characteristics (block 914). Using the immediately aforementioned example, the first group may have a common set of characteristics in that frequent use of a stove likely caused a fire, and the second group may have an entirely different common set of characteristics than the first group, in that the fire was caused by a simple accident (i.e., not the frequent use of a stove). Of course, more than two groups are contemplated.

To generate the claim risk profile based upon the historical claims data sorted into the two groups, the method 900 may proceed by counting the number of claims in each of the at least two groups (block 916), dividing the count total of each group by the total count of all the groups to determine a relative score (block 918), and normalizing the relative score of each group to calculate risk for each group having the common and distinct set of characteristics (block 920). Using the immediately aforementioned example, if the first group contained 9 claims and the second group contained 1 claim, the first group would have a relative score of 0.9 and the second group would have a relative score of 0.1, which may be normalized using any techniques as known in the art to generate the risk profile, such as the fire risk profile 512 as shown in FIG. 5.

The risks assessed, risk profiles created, and/or risk scores calculated may be used to dynamically generate or update one or more UBI products. For instance, based upon a risk profile created for an individual house, a homeowners UBI premium or rate may be dynamically adjusted to reflect less or more actual risk.

### Exemplary Method for Generating a Correlation Rule

FIG. 9B illustrates an exemplary method 930 for generating a correlation rule in accordance with an exemplary aspect of the present disclosure. In the present aspect, method 930 may be implemented by any suitable computing device (e.g., provider 130, as shown in FIG. 1, RC engine 400, as shown in FIG. 4, etc.). In one aspect, method 930 may be performed by one or more processors, applications, and/or routines, such as processor 402 executing correlation rule developer application 414, a graphical interface 600 associated with correlation rule developer application 414, and/or instructions stored in memory unit 410, for example, as shown in FIG. 4. In some embodiments, the provider 130 and/or RC engine 400 may be part of an insurance provider, financial provider, and/or service provider (or facilitate communications with an insurance, financial, and/or service provider), and as such, may access databases as needed to perform related functions.

Method 930 may begin by receiving a type of damage for which the correlation rule is generated (block 932). For example, a user may input the type of damage as “fire” using the graphical interface 600. Receiving the type of damage may align the correlation rule to compare datasets received from EM device 210 or controller 120 to risk profile 512 for fire damage as shown in FIG. 5.

Method 930 may proceed by receiving parameters for which the correlation rule is generated (block 934). For example, a user may input parameters such as “frequency portion” and “severity portion,” as shown in FIG. 6 using the graphical interface 600, to configure the processor 402 to compare both the actual frequency and severity portions of the dataset 300 to the expected frequency and severity portions of the expected electricity consumption characteristic. If the actual frequency and severity portions of the dataset 300 indicated that a particular household uses the stove more than 5 days out of the week and more than 2 hours each day, the processor 402 may compare both the actual frequency and severity portions to the expected frequency and severity portions of the expected electricity consumption characteristic to find the expected frequency and severity portions that closest match the actual frequency and severity portions, and determine that the risk of a fire starting in the household for dataset 300 corresponding to the closest matched expected frequency and severity portions of the risk profile 512 corresponds to a value of 0.7 (i.e., 70% likely), as shown at point 518 in FIG. 5.

Method 930 may proceed by receiving minimum level of the risk for which the correlation rule is generated (block 936). For example, a user may input the minimum level of the risk, which may correspond to lines 514 and 714 of risk profiles 512 and 712 for fire damage in FIGS. 5 and 7, respectively.

Method 930 may proceed by identifying the datasets having risk at or above the minimum level of the risk as specified by the correlation rule (block 936). For example, the selection made in field 606 as illustrated in FIG. 6 may configure the processor 402 to identify qualified datasets that meet or exceed the specified minimum level of the risk (i.e., correspond to a risk between points A and B on the curve in FIGS. 5 and 7). During the identification process, the processor 402 may compare the expected portions with the respective actual portions of the dataset 300 to determine risk that corresponds to the expected portions of the claim risk profiles that closest matches the actual portions from the dataset. If this risk exceeds the minimum level of the risk, the dataset 300 may be identified as “qualified” or otherwise “flagged.”

The datasets identified having risk at or above the minimum level of the risk as specified by the correlation rule (block 936) may be used to dynamically update the UBI products discussed herein. For instance, a dynamic homeowners UBI product may be dynamically adjust (such as have its periodic (such as weekly or monthly) premium dynamically updated to reflect less or more risk according to the datasets.

### Exemplary Method for Updating One or More Terms of a User Policy

FIG. 10 illustrates an exemplary method 1000 for dynamically updating one or more terms of a user policy (such as a dynamic homeowners UBI policy) contained in the user profile in accordance with an exemplary aspect of the present disclosure. In the present aspect, method 1000 may be implemented by any suitable computing device (e.g., provider 130, as shown in FIG. 1, RC engine 400, as shown in FIG. 4, etc.). In one aspect, method 1000 may be performed by one or more processors, applications, and/or routines, such as processor 402 executing claim risk profile creation application 412, correlation rule developer application 414, and/or instructions stored in memory unit 410, for example, as shown in FIG. 4. In some embodiments, the provider 130 and/or RC engine 400 may be part of an insurer computing system (or facilitate communications with an insurer computer system), and as such, may access insurer databases as needed to perform insurance-related functions.

Method 1000 may begin by receiving a dataset from the EM device via wireless communication or data transmission over one or more radio links or communication channels (block 1002). For example, the processor 402 of the provider 130 may receive dataset 300 from the EM device 210 or controller 120 via the network 125.

Method 1000 may proceed by parsing the actual portion(s) from the dataset and compare such portion(s) to the expected portion(s) of the one or more claim risk profiles, wherein the actual portion(s) and expected portion(s) are determined by the correlation rule (block 1004). For example, if the correlation rule has been configured to compare portions 306 and 308 to the expected portions of fire risk profile 512 of FIG. 5, the provider 130 may parse or otherwise extract the actual frequency portion 306 and actual severity portion 308 from the dataset 300 and compare such portions to the expected frequency and severity portions of the expected electricity consumption characteristic shown in fire risk profile 512.

Method 1000 may proceed by determining the risk that corresponds to the expected portion(s) of the one or more claim risk profiles that closest matches the actual portion(s) from the dataset (block 1006). When the dataset is determined to contain risk that meets or exceeds the minimum level of the risk, the method 1000 may proceed by parsing or otherwise extracting an account portion of the dataset (block 1008). For example, upon determining the risk of a fire starting in the household that corresponds to the expected frequency and severity portions of the risk profile 512 that closest matches the actual frequency portion 306 and actual severity portion 308 from the dataset 300, the processor 402 may parse or otherwise extract the account portion 302 from the dataset 300 as shown in FIG. 3 when the dataset 300 contains risk that meets or exceeds the minimum level of the risk (i.e., the risk meets or exceeds the minimum level of the risk), which may contain the user insurance profile ID, property 105 ID, or other identification information traceable to the user 150.

Method 1000 may proceed by retrieving a user profile associated with the account portion of the dataset (block 1010), and dynamically updating one or more terms of a user policy contained in the user profile (block 1012). For example, upon retrieving the user profile, the processor 402 may adjust (e.g., increase, decrease) a premium, rate, or discount for the customer. The user policy dynamically updated may be a dynamic homeowners UBI policy covering the home, in some embodiments. In other embodiments, the user policy dynamically updated may be a dynamic personal articles UBI policy covering devices using electricity drawn from the home's electrical system, or a dynamic auto UBI policy covering autos using electricity drawn from the home's electrical system to recharge batteries. The dynamic UBI policies may be generated and/or updated periodically, such as providing weekly or monthly insurance coverage.

In certain embodiments, whether the processor 402 increases or decreases a premium may depend on whether the risk of a fire starting in the household that corresponds to the expected frequency and severity portions of the risk profile 512 that closest matches the actual frequency portion 306 and actual severity portion 308 from the dataset 300 stays above or below the minimum level of the risk 514. The method 1000 may include additional, less, or alternate actions, including those discussed elsewhere herein.

A user 150 may access his or her user profile by logging onto remote electronic device 145 or controller 120. The provider 130 may receive, from remote electronic device 145 or controller 120, user credentials, which may be verified by the provider 130 or one or more other external computing devices or servers. These user credentials may be associated with an insurance profile, which may include, for example, financial account information, insurance policy numbers, a description and/or listing of insured assets (including property 105), vehicle identification numbers of insured vehicles, addresses of insured users, contact information, premium rates, discounts, and the likes.

In this way, data received from remote electronic device 145 or controller 120 may allow provider 130 to uniquely identify each insured customer. In addition, provider 130 may facilitate the communication of the updated insurance policies, premiums, rates, discounts, and the likes to their insurance customers for their review, modification, and/or approval, which may be viewed at the remote electronic device 145 or controller 120. Accordingly, the user 150 may obtain the adjusted premium from the provider 130.

In one embodiment, the provider 130 may increase an auto, personal, health, UBI, or dynamic UBI, or other insurance premium when the dataset 300 contains risk that meets or exceeds the minimum level of the risk. For example, if risk for dataset 300, when compared to the fire risk profile 712 as shown in FIG. 7, fits along the curve between points A and B, the processor 402 may detect that the dataset 300 exceeds the minimum level of the risk 714, and therefore dynamically adjust (e.g., increase) a premium for the customer.

In another embodiment, the provider 130 may lower an auto, personal, health, UBI, dynamic homeowners UBI, dynamic auto UBI, dynamic personal articles UBI, or other insurance premium, or otherwise provide a discount or other incentive, when the dataset 300 does not meet the minimum level of the risk. For example, if risk for dataset 300, when compared to the fire risk profile 712 as shown in FIG. 7, fits along the curve between points A and C, the processor 402 may detect that the dataset 300 does not meet the minimum level of the risk 714, and therefore dynamically adjust (e.g., lower) a premium for the customer.

Accordingly, the provider 130 may update or adjust an auto, personal, health, UBI, dynamic homeowners UBI, dynamic auto UBI, dynamic personal articles UBI, or other insurance premium or discount to reflect risk averse behavior based upon electricity activity measured from the EM device 210.

### Exemplary Method for Providing a Recommendation for Upgrading or Replacing an Electric Device

FIG. 11 illustrates an exemplary method 1100 for updating a user profile with a recommendation for upgrading or replacing the one or more individual electric or electronic devices with a determined upgrade or replacement device in accordance with an exemplary aspect of the present disclosure. In the present aspect, method 1100 may be implemented by any suitable computing device (e.g., provider 130, as shown in FIG. 1, RC engine 400, as shown in FIG. 4, etc.). In one aspect, method 1100 may be performed by one or more processors, applications, and/or routines, such as processor 402 executing claim risk profile creation application 412, correlation rule developer application 414, and/or instructions stored in memory unit 410, for example, as shown in FIG. 4. In some embodiments, the provider 130 and/or RC engine 400 may be part of a financial provider (or facilitate communications with a financial computer system), and as such, may access financial databases as needed to perform finance-related functions.

Method 1100 may begin by receiving a dataset from the EM device via wireless communication or data transmission over one or more radio links or communication channels (block 1102). For example, the processor 402 of the provider 130 may receive dataset 300 from the EM device 210 or controller 120 via the network 125.

Method 1100 may proceed by parsing the actual portion(s) from the dataset and compare such portion(s) to the expected portion(s) of the one or more claim risk profiles, wherein the actual portion(s) and expected portion(s) are determined by the correlation rule (block 1104). For example, if the correlation rule has been configured to compare portions 306 and 308 to the fire risk profile 512 of FIG. 5, the provider 130 may parse or otherwise extract the actual frequency portion 306 and actual severity portion 308 from the dataset 300 and compare such portions to the expected frequency and severity portions of the expected electricity consumption characteristic shown in fire risk profile 512.

Method 1100 may proceed by determining the risk that corresponds to the expected portion(s) of the one or more claim risk profiles that closest matches the actual portion(s) from the dataset (block 1106). When the dataset contains risk that meets or exceeds the minimum level of the risk, the method 1100 may proceed by parsing or otherwise extracting a replacement portion of the dataset to determine an upgrade or replacement device for the one or more individual electric or electronic devices (block 1108). For example, upon determining the risk of a fire starting in the household that corresponds to the expected frequency and severity portions of the risk profile 512 that closest matches the actual frequency portion 306 and actual severity portion 308 from the dataset 300, the processor 402 may parse or otherwise extract the replacement portion 310 from the dataset 300 as shown in FIG. 3 when the dataset 300 contains risk that meets or exceeds the minimum level of the risk (i.e., the risk meets or exceeds the minimum level of the risk), which may contain descriptions of replacement or upgrade devices (e.g., brand, model, serial number, ratings), price of the replacement or upgrade devices, replacement or upgrade compatibility information, vendors that sell the replacement or upgrade devices, etc.

Method 1100 may include, when the dataset contains risk that meets or exceeds the minimum level of the risk, dynamically updating, by the one or more processors, a dynamic homeowners usage-based insurance (UBI) policy premium or discount to reflect a current level of risk.

Method 1100 may proceed by parsing or otherwise extracting an account portion of the dataset (block 1110). For example, the processor 402 may parse or otherwise extract the account portion 302 from the dataset 300 as shown in FIG. 3, which may contain the user financial profile ID, property 105 ID, insurance profile ID, or other identification information traceable to the user 150.

Method 1100 may proceed by retrieving a user profile associated with the account portion of the dataset (block 1112), and dynamically updating a user profile with a recommendation for upgrading or replacing the one or more individual electric or electronic devices with the determined upgrade or replacement device (block 1114). For example, upon retrieving the user profile, the processor 402 may update the user profile with information as to how to obtain a replacement or upgraded stove, which may be a more energy efficient stove than the already existing stove 212, for the customer.

Method 1100 may include determining or verifying, via one or more processors, that the device have been upgraded or replaced. The dynamic UBI products discussed herein may then be dynamically updated or adjusted upon the device being upgraded or replaced. For instance, a dynamic homeowners UBI rate may be decreased or discount increase to reflect lower risk upon the device being upgraded or replaced. The method 1100 may include additional, less, or alternate actions, including those discussed elsewhere herein.

A user 150 may access his or her user profile by logging onto remote electronic device 145 or controller 120. The provider 130 may receive, from remote electronic device 145 or controller 120, user credentials, which may be verified by the provider 130 or one or more other external computing devices or servers. These user credentials may be associated with a financial profile, which may include, for example, financial account information, insurance policy numbers, a description and/or listing of insured assets (including property 105), vehicle identification numbers of insured vehicles, addresses of insured users, contact information, UBI or other premium rates, discounts, and the likes. In this way, data received from remote electronic device 145 or controller 120 may allow provider 130 to uniquely identify each customer. In addition, provider 130 may facilitate the communication of the recommendation for upgrading or replacing a device to their customers for their review, modification, and/or approval, which may be viewed at the remote electronic device 145 or controller 120. Accordingly, the user 150 may obtain the recommendation from the provider 130.

Accordingly, the provider 130 may provide a recommendation for upgrading or replacing a device based upon electricity activity measured from the EM device 210.

### Exemplary Method for Providing a Service Recommendation for Adjusting the Electricity Usage for an Electric Device

FIG. 12 illustrates an exemplary method 1200 for updating a user profile with a recommendation for adjusting the electricity consumption for the one or more individual electric or electronic devices in accordance with an exemplary aspect of the present disclosure. In the present aspect, method 1200 may be implemented by any suitable computing device (e.g., provider 130, as shown in FIG. 1, RC engine 400, as shown in FIG. 4, etc.). In one aspect, method 1200 may be performed by one or more processors, applications, and/or routines, such as processor 402 executing claim risk profile creation application 412, correlation rule developer application 414, and/or instructions stored in memory unit 410, for example, as shown in FIG. 4. In some embodiments, the provider 130 and/or RC engine 400 may be part of a service provider (or facilitate communications with a service computer system), and as such, may access service databases as needed to perform service-related functions.

Method 1200 may begin by receiving a dataset from the EM device via wireless communication or data transmission over one or more radio links or communication channels (block 1202). For example, the processor 402 of the provider 130 may receive dataset 300 from the EM device 210 or controller 120 via the network 125.

Method 1200 may proceed by parsing the actual portion(s) from the dataset and compare such portion(s) to the expected portion(s) of the one or more claim risk profiles, wherein the actual portion(s) and expected portion(s) are determined by the correlation rule (block 1204). For example, if the correlation rule has been configured to compare portions 306 and 308 to the fire risk profile 512 of FIG. 5, the provider 130 may parse or otherwise extract the actual frequency portion 306 and actual severity portion 308 from the dataset 300 and compare such portions to the expected frequency and severity portions of the expected electricity consumption characteristic shown in fire risk profile 512.

Method 1200 may proceed by determining the risk that corresponds to the expected portion(s) of the one or more claim risk profiles that closest matches the actual portion(s) from the dataset (block 1206). When the dataset contains risk that meets or exceeds the minimum level of the risk, the method 1100 may proceed by generating an energy savings plan based upon another dataset having a risk below the minimum level of the risk. For example, upon determining the risk of a fire starting in the household that corresponds to the expected frequency and severity portions of the risk profile 512 that closest matches the actual frequency portion 306 and actual severity portion 308 from the dataset 300, the processor 402 may generating an energy savings plan based upon another dataset (i.e., a reference dataset) when the dataset 300 contains risk that meets or exceeds the minimum level of the risk (i.e., the risk meets or exceeds the minimum level of the risk).

The reference dataset having a risk below the minimum level of the risk may indicate that another household with a comparable occupancy size as that of household associated with the dataset 300 uses a stove at times during which electrical power grid 206 does not exhibit high energy demand. Therefore, the energy savings plan may include directions to the user for shifting energy usage during partial-peak and off-peak hours. The energy savings plan may also include energy savings directions for reducing the actual frequency portion 306 and actual severity portion 308 of dataset 300 to reach corresponding frequency portion and severity portion of the reference dataset. In some embodiments, the method 1100 may generate an energy savings plan based upon an expected frequency portion and/or expected severity portion of a risk profile (e.g., risk profile 512) that correspond to a risk below the minimum level of the risk.

Method 1200 may proceed by parsing or otherwise extracting an account portion of the dataset (block 1210). For example, the processor 402 may parse or otherwise extract the account portion 302 from the dataset 300 as shown in FIG. 3, which may contain the user service profile ID, property 105 ID, insurance profile ID, or other identification information traceable to the user 150.

Method 1200 may proceed by retrieving a user profile associated with the account portion of the dataset (block 1212), and dynamically updating a user profile with a recommendation for adjusting the electricity consumption for the one or more individual electric or electronic devices (block 1214). For example, upon retrieving the user profile, the processor 402 may update the user profile with information as to how to use or operate the stove in a more efficient manner for the customer.

Method 1200 may also include when the dataset contains risk that meets or exceeds the minimum level of the risk, dynamically updating, by the one or more processors, a dynamic homeowners usage-based insurance (UBI) policy premium or discount to reflect the adjusted electricity consumption and/or lower or higher risk associated with the adjusted electricity consumption for the one or more individual electric or electronic devices.

The dynamically adjusted electricity consumption for electric devices, vehicles, and the house as a whole may be used to dynamically adjust one or more UBI products. For instance, a dynamic homeowners UBI policy may have its periodic premium dynamically lowered, or its periodic dynamic discount dynamically increased, to reflect less risk due to lower electricity consumption. The method 1200 may include additional, less, or alternate actions, including those discussed elsewhere herein.

A user 150 may access his or her user profile by logging onto remote electronic device 145 or controller 120. The provider 130 may receive, from remote electronic device 145 or controller 120, user credentials, which may be verified by the provider 130 or one or more other external computing devices or servers. These user credentials may be associated with a service profile, which may include, for example, service account information, insurance policy numbers, a description and/or listing of insured assets (including property 105), vehicle identification numbers of insured vehicles, addresses of insured users, contact information, premium rates, discounts, and the likes. In this way, data received from remote electronic device 145 or controller 120 may allow provider 130 to uniquely identify each customer. In addition, provider 130 may facilitate the communication of the recommendation for adjusting the electricity consumption for the one or more individual electric or electronic devices to their customers for their review, modification, and/or approval, which may be viewed at the remote electronic device 145 or controller 120. Accordingly, the user 150 may obtain the recommendation from the provider 130.

Accordingly, the provider 130 may provide a recommendation for adjusting the energy usage of the existing electric or electronic device based upon electricity activity measured from the EM device 210.

### Exemplary Technical Advantages

The embodiments described herein may be implemented as part of a computer network architecture, and thus address and solve issues of a technical nature that are necessarily rooted in computer technology. For instance, embodiments include building specific types of risk profiles based upon historical electrical usage, flow, and/or consumption of known electric or electronic devices and performing specific types of correlations as specified by various rule parameters by correlating datasets associated with individual electric or electronic devices to the risk profiles. In doing so, the embodiments overcome issues associated with estimating risk for electrical usage per electric or electronic device.

That is, conventionally, electricity usage analysis systems and consumers are typically only able to view general electricity usage at the household level, such as data provided by an energy bill to the consumer. The embodiments described herein not only detect individual electric or electronic devices' electricity usage, but also compares the individual electric or electronic devices' electricity usage to a novel claim risk profile that correlates historical individual electric or electronic devices' electricity consumption information from a plurality of households with property risk. Without the improvements suggested herein, electricity usage analysis systems would at least be unable to determine whether electricity usage of specific electric or electronic device is contributing to risk of damaging a home or other property. Conventionally systems also are unable to provide the customer with ways to lower the risk.

Furthermore, the embodiments described herein function to improve efficiency over time. For example, as the RC engine 400 continues to obtain and monitor claims data, the RC engine 400 may refine the risk profiles to accurately determine a set of characteristics common to claims filed for numerous homes that resulted in damages to homes, to provide preventative measures and more awareness for specific households exhibiting a similar set of characteristics. Therefore, not only do the embodiments address computer-related issues regarding novel techniques, but they also improve over time. By learning and improving over time, the embodiments address computer related issues that are related to accuracy metrics.

### Additional Considerations

With the foregoing, any users (e.g., insurance customers) whose data is being collected and/or utilized may first opt-in to a rewards, insurance discount, or other type of program. After the user provides their affirmative consent or permission, data may be collected from the user's devices (e.g., EM device, mobile device, smart or autonomous vehicle controller, smart home controller, or other smart devices). In return, the user may be entitled insurance cost savings, including insurance discounts for auto, homeowners, mobile, renters, personal articles, life, health, and/or other types of insurance or UBI.

This detailed description is to be construed as exemplary only and does not describe every possible embodiment, as describing every possible embodiment would be impractical, if not impossible. One may be implement numerous alternate embodiments, using either current technology or technology developed after the filing date of this application.

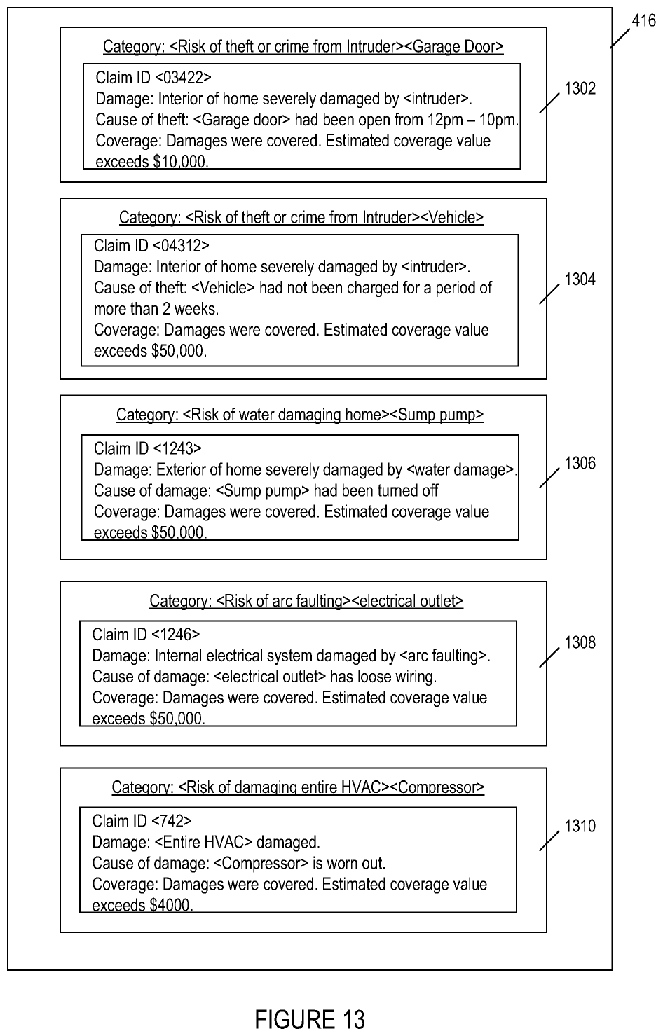

Further to this point, although the embodiments described herein often refer to risk of a fire starting in a home based upon usage of a stove (e.g., electric device 212d), the embodiments described herein are not limited to such example. Frequent and/or severe use of other electric or electronic devices may cause a fire, such as washer 212f and dryer 212g of home 202 depicted in FIG. 2. The embodiments described herein are also not limited to damages to a home caused by a fire. As shown in FIG. 13, other home damages are contemplated, such as theft of items inside a home or other crime conducted by an intruder, water damage to a home, arc faulting in a home, appliances breaking down in a home, etc.

For example, a risk profile may be determined from claims data 416 including claim 1302 that defines risk corresponding to historical electricity consumption information from an electronic device such as a garage door opener. The EM device 210 may wirelessly detect a unique electric signature of the garage door opener located in the garage of home 202. From the claim 1302, the RC engine 400 may determine a pattern of infrequent use of the garage door opener that likely caused an intruder to enter the home 202 through the open garage. As a result, theft of personal property, or even crime, may have occurred within the home 202. A provider 130 in the business of providing homeowner polices or life insurance policies to customers, via the RC engine 400, may develop a risk profile based upon historical electricity consumption information specifically as a result of usage of the garage door opener.

The risk profile, similar to profile 512, may indicate a high risk of damage for infrequent use of the garage door opener and low risk of damage for frequent use of the garage door opener. The RC engine 400 may also specify the minimum level of the risk on the risk profile, such that upon receiving an actual dataset including actual electricity consumption information from a garage door opener, the RC engine 400 may flag the dataset if the risk associated with the actual electricity consumption information that closest matches a risk of the profile that exceeds the minimum level of the risk.

As another example, a risk profile may be determined from claims data 416 including claim 1304 that defines risk corresponding to historical electricity consumption information from an electronic device such as a battery charging station for a vehicle 212b. The EM device 210 may wirelessly detect a unique electric signature of the battery charging station located in the garage of home 202. From the claim 1304, the RC engine 400 may determine a pattern of infrequent use of the battery charging station (e.g., because the vehicle 212b has not been in the garage for an extended period of time and thus has not been charging) that likely caused an intruder to enter the home 202 knowing that the homeowners were not home. As a result, theft of personal property, or even crime, may have occurred within the home 202.

A provider 130 in the business of providing homeowner polices or life insurance policies to customers, via the RC engine 400, may develop a risk profile based upon historical electricity consumption information specifically as a result of usage of the battery charging station. The risk profile, similar to profile 512, may indicate a high risk of damage for infrequent use of the battery charging station and low risk of damage for frequent use of the battery charging station. The RC engine 400 may also specify the minimum level of the risk on the risk profile, such that upon receiving an actual dataset including actual electricity consumption information from a battery charging station, the RC engine 400 may flag the dataset if the risk associated with the actual electricity consumption information that closest matches a risk of the profile that exceeds the minimum level of the risk.

As another example, a risk profile may be determined from claims data 416 including claim 1306 that defines risk corresponding to historical electricity consumption information from an electronic device such as a sump pump. The EM device 210 may wirelessly detect a unique electric signature of the sump pump located in the basement of home 202. From the claim 1306, the RC engine 400 may determine a pattern of infrequent use of the sump pump (e.g., because the sump pump is broken or has been shut off for an extended period of time) that likely caused flooding in the basement or surrounding areas.

A provider 130 in the business of providing homeowner polices to customers, via the RC engine 400, may develop a risk profile based upon historical electricity consumption information specifically as a result of usage of the sump pump. The risk profile, similar to profile 512, may indicate a high risk of damage for infrequent use of the sump pump and low risk of damage for frequent use of the sump pump. The RC engine 400 may also specify the minimum level of the risk on the risk profile, such that upon receiving an actual dataset including actual electricity consumption information from a sump pump, the RC engine 400 may flag the dataset if the risk associated with the actual electricity consumption information that closest matches a risk of the profile that exceeds the minimum level of the risk.

As another example, a risk profile may be determined from claims data 416 including claim 1308 that defines risk corresponding to historical electricity consumption information from an electronic device such as an electrical outlet 212h. The EM device 210 may wirelessly detect a unique electric signature of the electrical outlet located in any area of home 202. From the claim 1308, the RC engine 400 may determine a pattern of servere use of the electrical outlet (e.g., thus loosening of the wires associated with the electrical outlet) that likely caused arc faulting in the home.

A provider 130 in the business of providing homeowner polices to customers, via the RC engine 400, may develop a risk profile based upon historical electricity consumption information specifically as a result of usage of the electrical outlet. The risk profile, similar to profile 512, may indicate a high risk of damage for severe use of the electrical outlet and low risk of damage for less severe use of the electrical outlet. The RC engine 400 may also specify the minimum level of the risk on the risk profile, such that upon receiving an actual dataset including actual electricity consumption information from a electrical outlet, the RC engine 400 may flag the dataset if the risk associated with the actual electricity consumption information that closest matches a risk of the profile that exceeds the minimum level of the risk.

As another example, a risk profile may be determined from claims data 416 including claim 1308 that defines risk corresponding to historical electricity consumption information from an electronic device such as an HVAC or furnace 212a. The EM device 210 may wirelessly detect a unique electric signature of the HVAC or furnace located in the basement, first floor, or even rooftop of home 202. From the claim 1310, the RC engine 400 may determine a pattern of frequent and/or servere use of the HVAC or furnace (e.g., thus malfunctioning of a component within the HVAC or furnace, such as a compressor) that likely caused the entire HVAC or furnace to break down.

A provider 130 in the business of providing homeowner polices to customers, via the RC engine 400, may develop a risk profile based upon historical electricity consumption information specifically as a result of usage of the HVAC or furnace. The risk profile, similar to profile 512, may indicate a high risk of damage for frequent and/or severe use of the HVAC or furnace and low risk of damage for less frequent and/or severe use of the HVAC or furnace. The RC engine 400 may also specify the minimum level of the risk on the risk profile, such that upon receiving an actual dataset including actual electricity consumption information from a HVAC or furnace, the RC engine 400 may flag the dataset if the risk associated with the actual electricity consumption information that closest matches a risk of the profile that exceeds the minimum level of the risk.

Furthermore, although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

1. A computer-implemented method of evaluating usage of one or more individual electric or electronic devices powered via an electrical system of a home, the method comprising:
receiving, by one or more processors, a dataset indicative of the one or more individual electric or electronic devices' electricity consumption via wireless communication or data transmission over one or more radio links or communication channels;
generating, by the one or more processors, one or more claim risk profiles, each of the one or more claim risk profiles being associated with a type and a cause of property damage selected by a computing device, being generated based upon historical claims data and historical electricity consumption information for the type of property damage, and defining a minimum level of risk for the type of property damage, the type of property damage indicating a type of damage associated with the property damage and the cause of the property damage indicating one or more devices that caused the property damage;
generating, in response to receiving an input from the computing device and by the one or more processors, a correlation rule for a selected type of property damage by specifying one or more parameters that indicate which portion of the dataset is to be compared to a corresponding claim risk profile of the selected type of property damage;
detecting, by the one or more processors, whether the portion of the dataset contains risk that meets or exceeds the minimum level of the risk defined in the corresponding claim risk profile in accordance with the one or more parameters specified by the correlation rule; and
when the dataset contains risk that meets or exceeds the minimum level of the risk, dynamically updating, by the one or more processors, a user profile with a recommendation for upgrading or replacing the one or more individual electric or electronic devices.

2. The computer-implemented method of claim 1, the method further comprising:
when the dataset contains risk that meets or exceeds the minimum level of the risk, dynamically updating, by the one or more processors, a dynamic homeowners usage-based insurance (UBI) policy premium or discount to reflect a current level of risk.

3. The computer-implemented method of claim 1, further comprising:
parsing a replacement portion of the dataset when the dataset contains risk that meets or exceeds the minimum level of the risk to determine an upgrade or replacement device for the one or more individual electric or electronic devices; and
dynamically updating the user profile with the determined upgrade or replacement device.

4. The computer-implemented method of claim 3, wherein the replacement portion comprises at least one of descriptions of the upgrade or replacement device, price of the upgrade or replacement device, replacement or upgrade compatibility information for the upgrade or replacement device, or vendors that sell the upgrade or replacement device.

5. The computer-implemented method of claim 4, further comprising:
parsing an account portion of the dataset;
retrieving the user profile associated with the account portion of the dataset; and
dynamically updating the retrieved user profile with the recommendation for upgrading or replacing the one or more individual electric or electronic devices with the determined upgrade or replacement device.

6. The computer-implemented method of claim 5, wherein the recommendation further comprises a loan, a line of equity, a line of credit, a discount, or an incentive to purchase the determined upgrade or replacement device.

7. The computer-implemented method of claim 1, wherein the one or more parameters comprises at least one of a frequency portion or a severity portion of the dataset.

8. The computer-implemented method of claim 7, wherein the one or more parameters further comprise a home occupancy portion of the dataset.

9. The computer-implemented method of claim 1, wherein generating the one or more claim risk profiles comprises:
sorting historical claims data by type of property damage;
selecting a type of property damage;
identify the historical electricity consumption information for the selected type of property damage; and
generating the one or more claim risk profiles for the selected type of property damage based upon the historical electricity consumption information.

10. The computer-implemented method of claim 9, further comprising:
sorting the historical claims data corresponding to the selected type of property damage into at least two groups, each group having a common and distinct set of characteristics;
counting a number of claims in each of the at least two groups;
dividing the number of counted claims in each of the at least two groups by a total number of claims in the at least two groups combined; and
normalizing a relative score of each of the at least two groups to calculate risk for each group having the common and distinct set of characteristics.

11. The computer-implemented method of claim 1, further comprising:
transmitting, by the one or more processors, the updated user profile to a remote device.

12. A risk correlation engine, comprising:
a memory unit configured to store instructions for evaluating usage of one or more individual electric or electronic devices powered via an electrical system of a home;
a processor communicatively coupled to the memory unit, the processor configured to execute the instructions stored in the memory to cause the processor to:
receive a dataset indicative of the one or more individual electric or electronic devices' electricity consumption via wireless communication or data transmission over one or more radio links or communication channels;
generate one or more claim risk profiles, each of the one or more claim risk profiles being associated with a type and a cause of property damage selected by a computing device, being generated based upon historical claims data and historical electricity consumption information for the type of property damage, and defining a minimum level of risk for the type of property damage, the type of property damage indicating a type of damage associated with the property damage and the cause of the property damage indicating one or more devices that caused the property damage;
generate, in response to receiving an input from the computing device, a correlation rule for a selected type of property damage by specifying one or more parameters that indicate which portion of the dataset is to be compared to a corresponding claim risk profile of the selected type of property damage;
detect whether the portion of the dataset contains risk that meets or exceeds the minimum level of the risk defined in the corresponding claim risk profile in accordance with the one or more parameters specified by the correlation rule; and
when the dataset contains risk that meets or exceeds the minimum level of the risk, dynamically update a user profile with a recommendation for upgrading or replacing the one or more individual electric or electronic devices.

13. The risk correlation engine of claim 12, wherein the processor is further configured to:
when the dataset contains risk that meets or exceeds the minimum level of the risk, dynamically update a dynamic homeowners usage-based insurance (UBI) policy premium or discount to reflect a current level of risk.

14. The risk correlation engine of claim 12, wherein the processor is further configured to:
parse a replacement portion of the dataset when the dataset contains risk that meets or exceeds the minimum level of the risk to determine an upgrade or replacement device for the one or more individual electric or electronic devices; and
dynamically update the user profile with the determined upgrade or replacement device.

15. The risk correlation engine of claim 14, wherein the replacement portion comprises at least one of descriptions of the upgrade or replacement device, price of the upgrade or replacement device, replacement or upgrade compatibility information for the upgrade or replacement device, or vendors that sell the upgrade or replacement device.

16. The risk correlation engine of claim 15, wherein the processor is further configured to:
parse an account portion of the dataset;
retrieve the user profile associated with the account portion of the dataset; and
dynamically update the retrieved user profile with the recommendation for upgrading or replacing the one or more individual electric or electronic devices with the determined upgrade or replacement device.

17. The risk correlation engine of claim 12, wherein the recommendation further comprises a loan, a line of equity, a line of credit, a discount, or an incentive to purchase the determined upgrade or replacement device.

18. The risk correlation engine of claim 12, wherein the one or more parameters further comprise a home occupancy portion of the dataset.

19. The risk correlation engine of claim 12, wherein the processor is configured to generate the one or more claim risk profiles by:
sorting historical claims data by type of property damage;
selecting a type of property damage;
identify the historical electricity consumption information for the selected type of property damage; and
generating the one or more claim risk profiles for the selected type of property damage based upon the historical electricity consumption information.

20. A non-transitory, tangible computer-readable medium storing machine readable instructions that, when executed by a processor, cause the processor to:
receive a dataset indicative of the one or more individual electric or electronic devices' electricity consumption via wireless communication or data transmission over one or more radio links or communication channels;
generate one or more claim risk profiles, each of the one or more claim risk profiles being associated with a type and a cause of property damage selected by a computing device, being generated based upon historical claims data and historical electricity consumption information for the type of property damage, and defining a minimum level of risk for the type of property damage, the type of property damage indicating a type of damage associated with the property damage and the cause of the property damage indicating one or more devices that caused the property damage;
generate, in response to receiving an input from the computing device, a correlation rule for a selected type of property damage by specifying one or more parameters that indicate which portion of the dataset is to be compared to a corresponding claim risk profile of the selected type of property damage;
detect whether the portion of the dataset contains risk that meets or exceeds the minimum level of the risk defined in the corresponding claim risk profile in accordance with the one or more parameters specified by the correlation rule; and
when the dataset contains risk that meets or exceeds the minimum level of the risk, dynamically update a user profile with a recommendation for upgrading or replacing the one or more individual electric or electronic devices.
